(19) United States
(12) Patent Application Publication
(10) Pub. No.: US 2023/0419287 A1
(43) Pub. Date: Dec. 28, 2023

(54) SYSTEMS AND METHODS FOR AUGMENTED COMMUNICATIONS USING MACHINE-READABLE LABELS

(71) Applicant: LIVEPERSON, INC., New York, NY (US)

(72) Inventor: Bruce Ramsay, JR., New York, NY (US)

(73) Assignee: LIVEPERSON, INC., New York, NY (US)

(21) Appl. No.: 18/214,717

(22) Filed: Jun. 27, 2023

Related U.S. Application Data
(60) Provisional application No. 63/356,103, filed on Jun. 28, 2022.

(51) Int. Cl. G06Q 20/20; G06Q 20/40

(52) U.S. Cl. CPC G06Q 20/202; G06Q 20/208; G06Q 20/401

(57) ABSTRACT

Disclosed embodiments provide a framework for generating machine-readable labels for augmenting existing communications sessions between users and automated bot agents. During a communications session facilitated between a user and an automated bot through a point-of-sale terminal, the automated bot may automatically, and in real-time, process any communications as these communications are exchanged to determine whether to facilitate an alternative communications channel. If so, the automated bot generates a machine-readable label that can be presented through the point-of-sale terminal. When the machine-readable label is scanned using a computing device, the automated bot facilitates an alternative communications session between the user and the automated bot through the computing device while the original communications session is ongoing.

### CROSS-REFERENCE TO RELATED APPLICATIONS

The present patent application claims the priority benefit of U.S. provisional patent application No. 63/356,103 filed Jun. 28, 2022, the disclosures of which are incorporated by reference herein.

### FIELD

The present disclosure relates generally to systems and methods for generating machine-readable labels for augmenting existing communications sessions between users and automated bot agents.

### SUMMARY

Disclosed embodiments may provide a framework for generating machine-readable labels for augmenting existing communications sessions between users and automated bot agents. According to some embodiments, a computer-implemented method is provided. The computer-implemented method comprises detecting a user at a point-of-sale terminal. The point-of-sale terminal is associated with an agent. Further, the agent communicates with users through a communications channel associated with the point-of-sale terminal. The computer-implemented method further comprises identifying one or more characteristics associated with the user. The one or more characteristics are used to associate a communications session between the user and the agent with the user. The computer-implemented method further comprises initiating the communications session between the user and the agent. The communications session is facilitated through the point-of-sale terminal. The computer-implemented method further comprises dynamically generating in real-time a machine-readable label associated with the communications session. The machine-readable label encodes the one or more characteristics associated with the user and information corresponding to the communications session. The computer-implemented method further comprises providing the machine-readable label. When the machine-readable label is received at the point-of-sale terminal, the point-of-sale terminal presents the machine-readable label. The computer-implemented method further comprises receiving a request to initiate an alternative communications session between the user and the agent. The request includes the one or more characteristics associated with the user and the information corresponding to the communications session extracted from the machine-readable label. The computer-implemented method further comprises facilitating the alternative communications session.

In some embodiments, the alternative communications session is facilitated while the communications session is ongoing through the point-of-sale terminal.

In some embodiments, the computer-implemented further comprises identifying in real-time an intent corresponding to ongoing communications exchanged between the user and the agent through the communications session and the alternative communications session. The computer-implemented method further comprises automatically transferring the alternative communications session to another agent. The alternative communications session is transferred to the other agent according to the intent.

In some embodiments, the machine-readable label is a Quick Response (QR) code.

In some embodiments, the user is detected as a result of one or more sensors implemented on the point-of-sale terminal detecting the user.

In some embodiments, the computer-implemented method further comprises encoding a location associated with the point-of-sale terminal in the machine-readable label. The location is used to customize communications provided through the alternative communications session.

In some embodiments, the computer-implemented method further comprises receiving a payment request over the communications session. The computer-implemented method further comprises transmitting an authorization request for a payment over the alternative communications session. The computer-implemented method further comprises receiving authorization data over the alternative communications session. The authorization data is used to obtain the payment.

In some embodiments, the machine-readable label is dynamically generated as communications are exchanged over the communications session.

In some embodiments, the request to initiate the alternative communications session is received as a result of the machine-readable label being scanned using a computing device associated with the user.

In some embodiments, the alternative communications session is facilitated using an alternative communications channel between the user and the agent.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The present disclosure is described in conjunction with the appended Figures:

FIG. 1 shows an illustrative example of an environment in which an agent bot engaged in a communications session with a user augments the communications session with a machine-readable label usable to facilitate an alternative communications session between the user and the agent bot in accordance with at least one embodiment;

FIGS. 2A-2B show an illustrative example of an environment in which an intent extraction system associated with a brand platform service monitors a communications session in real-time to determine whether to augment the communications session with a machine-readable label usable to facilitate an alternative communications session in accordance with at least one embodiment;

FIG. 3 shows an illustrative example of an environment in which an interface associated with a point-of-sale terminal is updated to provide a machine-readable label usable to facilitate an alternative communications session between a user and an agent bot in accordance with at least one embodiment;

FIGS. 4A-4C show an illustrative example of an environment in which a user, through a computing device, scans a provided machine-readable label to request facilitation of an alternative communications session between the user and an agent bot in accordance with at least one embodiment;

FIG. 5 shows an illustrative example of a process for augmenting a communications session with a machine-readable label usable to facilitate an alternative communications session between a user and an agent bot in accordance with at least one embodiment;

FIG. 6 shows an illustrative example of a process for facilitating an alternative communications session between a user and an agent bot in response to the scanning of a machine-readable label associated with an initial communications session in accordance with at least one embodiment;

FIG. 7 shows an illustrative example of a process for monitoring in real-time communications between a user and an agent bot through one or more communications sessions to determine whether to transfer a communications session from the agent bot to a live agent in accordance with at least one embodiment; and

FIG. 8 shows an illustrative example of an environment in which various embodiments can be implemented.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred examples of embodiment(s) only and is not intended to limit the scope, applicability or configuration of the disclosure. Rather, the ensuing description of the preferred examples of embodiment(s) will provide those skilled in the art with an enabling description for implementing a preferred examples of embodiment. It is understood that various changes can be made in the function and arrangement of elements without departing from the spirit and scope as set forth in the appended claims.

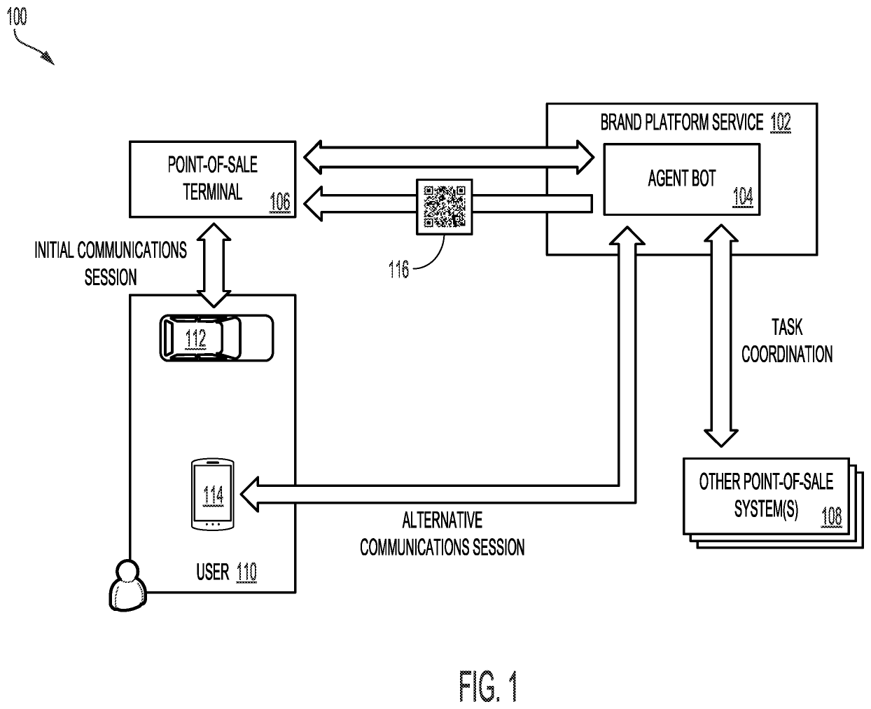

FIG. 1 shows an illustrative example of an environment 100 in which an agent bot 104 engaged in a communications session with a user 110 augments the communications session with a machine-readable label 116 usable to facilitate an alternative communications session between the user 110 and the agent bot 104 in accordance with at least one embodiment. In the environment 100, a user 110 may approach a point-of-sale terminal 106 associated with a brand platform service 102 to initiate a communications session with an agent bot 104 implemented by the brand platform service 102. The brand platform service 102 may be an entity that provides, operates, or runs an online service for providing assistance to users associated with a brand or other organization that provides services and/or goods to its users, such as user 110. For instance, the brand platform service 102 may provide user support on behalf of the brand or other organization. In some embodiments, the brand platform service 102 is provided by the brand or other organization to process requests and/or issues submitted by users associated with the brand.

The point-of-sale terminal 106 may be implemented at a site associated with a particular retailer or brand. For example, the point-of-sale terminal 106 may be implemented within a digital drive-thru menu board installed at a fast-food restaurant or other retailer that allows users to purchase goods through a drive-thru window. As another illustrative example, the point-of-sale terminal 106 may be implemented at a brick-and-mortar store, such as at payment registers or kiosks through which users may complete a checkout process to purchase goods from a particular retailer associated with the brick-and-mortar store.

In an embodiment, the point-of-sale terminal 106 is implemented as a computing device that integrates one or more components for facilitating communications sessions between users and agents (e.g., agent bots, live agents, etc.) associated with the brand platform service 102. For instance, the point-of-sale terminal 106 may include a speaker system through which a user 110 can verbally communicate with the point-of-sale terminal 106 and that can reproduce any audial transmissions from the agent bot 104 associated with the point-of-sale terminal 106, as described in greater detail herein. Additionally, the point-of-sale terminal 106 may include an interface through which messages exchanged between the agent bot 104 and the user 110 during the communications session may be displayed to the user 110 in real-time as these messages are received at the point-of-sale terminal 106.

In an embodiment, the point-of-sale terminal 106 maintains an active network connection with the brand platform service 102 in order to facilitate communications sessions between users and agent bots through the point-of-sale terminal 106. For instance, if a user 110 submits a request, through the point-of-sale terminal 106, to facilitate a communications session between the user 110 and the agent bot 104 through the point-of-sale terminal 106, the point-of-sale terminal 106 may transmit the request over this network connection to the brand platform service 102. In response to the request, the brand platform service 102 may facilitate the communications session between the user 110 and the agent bot 104, whereby communications between the user 110 and the agent bot 104 may be exchanged, in real-time, through the point-of-sale terminal 106.

In an embodiment, the point-of-sale terminal 106 includes one or more sensors that are implemented to detect when a user 110 has entered within a particular spatial range of the point-of-sale terminal 106. For example, if the user 110 is in a vehicle 112, the point-of-sale terminal 106, through these one or more sensors, may detect when the vehicle 112 enters within a particular spatial distance from the point-of-sale terminal 106. Further, when the vehicle 112 enters within this particular spatial distance from the point-of-sale terminal 106, through the one or more sensors, the point-of-sale terminal 106 may determine whether the spatial distance between the vehicle 112 and the point-of-sale terminal 106 is decreasing. If so, the point-of-sale terminal 106 may determine that the vehicle 112 is approaching the point-of-sale terminal 106 and that a user 110 associated with the vehicle 112 is seeking to initiate a communications session for a particular purpose (e.g., ordering food from a fast-food restaurant, etc.).

If the point-of-sale terminal 106 detects that a user 110 has arrived (e.g., the user 110 is within a particular spatial range of the point-of-sale terminal 106, etc.), the point-of-sale terminal 106 may automatically, and in real-time, transmit a notification to the brand platform service 102 to initiate a communications session between the user 110 and an agent bot 104. An agent bot 104 may be an automated process that is implemented or dynamically trained to communicate with users associated with the brand that implements the point-of-sale terminal 106 in order to provide information to these users regarding goods and/or services offered at the point-of-sale and/or to address any issues or requests submitted by a user 110 (e.g., requests for refunds, etc.). The user 110, in some instances, can be an individual purchasing one or more food items offered at the point-of-sale, a brand can be a company that sells various food items from the point-of-sale, and the agent bot 104 can be implemented by the brand platform service 102 to autonomously communicate with the user 110 to provide information with regard to the food items offered by the brand and to collect the user's order for any food items that the user 110 may wish to purchase and obtain at the point-of-sale.

In an embodiment, the agent bot 104 uses a machine learning algorithm or artificial intelligence to automatically, and autonomously, process communications from the user 110 through the point-of-sale terminal 106 in real-time as these communications are exchanged. The machine learning algorithm may be implemented to perform a semantic analysis of the responses (e.g., by identifying keywords, sentence structures, repeated words, punctuation characters and/or non-article words) to identify any information in these communications that may correspond to an order or request. Further, using this machine learning algorithm or artificial intelligence, the agent bot 104 may extract an intent associated with the communications session between the user 110 and the agent bot 104 through the point-of-sale terminal 106. An intent may correspond to an issue that the user 110 wishes to have resolved. Examples of intents can include (for example) topic, sentiment, complexity, and urgency. A topic can include, but is not limited to, a subject, a product, a service, a technical issue, a use question, a complaint, a refund request or a purchase request, etc. An intent can be determined, for example, based on a semantic analysis of a communication (e.g., by identifying keywords, sentence structures, repeated words, punctuation characters and/or non-article words); user input (e.g., having selected one or more categories); and/or communication-associated statistics (e.g., response latency, etc.).

The machine learning algorithm or artificial intelligence utilized by the agent bot 104 may be dynamically trained using supervised learning techniques. For instance, a dataset of recorded communications sessions between users and agents (e.g., agent bots, live agents, etc.) and annotations (e.g., identified intents, known information for an order or request, etc.) corresponding to communications exchanged during these communications sessions can be selected for training of the machine learning algorithm or artificial intelligence. The recorded communications sessions included in the dataset may include recordings of historical communications sessions between users and agents, recordings of hypothetical communications sessions between hypothetical users and agents, and/or a combination thereof. In some implementations, known orders or intents used to train the machine learning algorithm or artificial intelligence may include characteristics of these orders or intents. The machine learning algorithm or artificial intelligence may be evaluated to determine, based on the input sample communications sessions supplied to the machine learning algorithm or artificial intelligence, whether the machine learning algorithm or artificial intelligence is identifying the expected information and/or intents and selecting an appropriate action (e.g., transferring an order to other point-of-sale systems 108, escalating the communications session to another agent, providing relevant responses or follow-up communications, etc.) based on the communications provided by users corresponding to these sample communications sessions. Based on this evaluation, the machine learning algorithm or artificial intelligence may be dynamically modified to increase the likelihood of the machine learning algorithm or artificial intelligence generating the desired results. The machine learning algorithm or artificial intelligence may further be dynamically trained by soliciting feedback from users with regard to the fulfillment of an order or request submitted through the point-of-sale terminal 106. For instance, the brand platform service 102 may record, in real-time, user interactions with the agent bot 104 for a particular order or request to determine whether the user 110 is satisfied with the performance of the agent bot 104. These user interactions may be used to dynamically train the machine learning algorithm or artificial intelligence based on the accuracy of the agent bot 104, using the machine learning algorithm or artificial intelligence, in processing and resolving the user's order or other request initiated through the point-of-sale terminal 106.

In an embodiment, the machine learning algorithm or artificial intelligence utilized by the agent bot 104 can include natural language processing (NLP), interactive voice recognition systems, and other forms of conversational voice algorithms and systems. This may allow the agent bot 104 to communicate with a user 110 through the point-of-sale terminal 106, such as through the speaker system implemented by the point-of-sale terminal 106 and through which a user 110 can verbally communicate with the agent bot 104 through the point-of-sale terminal 106. In some instances, if the point-of-sale terminal 106 implements an interface through which the user 110 may generate and transmit text-based communications to the agent bot 104 (e.g., a touchscreen interface, etc.), the agent bot 104, using the machine learning algorithm or artificial intelligence, may generate text-based responses to these communications that may be presented to the user 110 through the interface.

As the user 110 communicates with the agent bot 104 through the point-of-sale terminal 106, the agent bot 104 may dynamically, and in real-time, process any communications from the user 110 to determine whether processing of the user's order or request is becoming difficult over the point-of-sale terminal 106. For example, if the agent bot 104 detects an elevated amount of environmental noise that is obfuscating the user's communications, the agent bot 104 may determine that an alternative communications session should be established with the user 110 in order to fulfill the new order or request from the user 110. As another illustrative example, if the agent bot 104 determines that the user 110 has one or more accessibility needs (e.g., the user 110 is hearing impaired, the user 110 cannot understand the agent bot 104 over the point-of-sale terminal 106, etc.), the agent bot 104 may determine that an alternative communications session should be established with the user 110 in order to fulfill the new order or request from the user 110.

In some instances, the agent bot 104, through the aforementioned machine learning algorithm or artificial intelligence, may detect one or more anchor terms or phrases that may indicate a need to establish an alternative communications session between the user 110 and the agent bot 104 for the order or request. For example, if the user 110 states, through the point-of-sale terminal 106, “I can't understand what you're asking,” the agent bot 104 may process this statement in real-time using the machine learning algorithm or artificial intelligence to detect the anchor phrase “can't understand.” This anchor phrase may be used by the agent bot 104 to determine that the user 110 is having a difficult time understanding the agent bot 104, thereby requiring an alternative communications session to continue the order or other request being submitted by the user 110.

In an embodiment, if the agent bot 104 determines that an alternative communications session should be established between the user 110 and the agent bot 104 to continue the order or other request being submitted by the user 110, the agent bot 104 can dynamically, and automatically, use any identifying information associated with the user 110 (e.g., license plate number associated with the user's vehicle 112, the make and model of the user's vehicle 112, an image of the user 110 captured by the point-of-sale terminal 106, etc.) and any other information associated with the order or request being submitted (e.g., an order number, a timestamp, a communications session identifier, etc.) to dynamically generate a machine-readable label 116. The machine-readable label 116, as illustrated in FIG. 1, may be implemented as a Quick Response (QR) code that encodes the identifying information associated with the user 110 and any other information associated with the order or request being submitted. In some instances, the machine-readable label 116 may further encode a Uniform Resource Identifier (URI) corresponding to a website that may be used to assist the user 110 in completing their order or request. For instance, the URI may correspond to a website that includes a menu associated with the brand that implements the point-of-sale terminal 106. This URI, when processed by a user's computing device 114, may cause the user's computing device 114 to execute a browser application or other application implemented on the user's computing device 114 to access the website. In some instances, the machine-readable label 116 may encode executable instructions that may cause the user's computing device 114 to execute an application associated with the brand.

It should be noted that while QR codes are used extensively throughout the present disclosure for the purpose of illustration, other machine-readable labels may be implemented to encode the aforementioned information and executable instructions. For example, the machine-readable label 116 may include an image of the user's vehicle 112 captured by the point-of-sale terminal 106. This image may be associated, by the agent bot 104, with the aforementioned information such that, when the user 110 scans the image of the user's vehicle 112 from the point-of-sale terminal 106 using their computing device 114, the user 110 may upload the image to a website associated with the brand to access any information usable to assist the user 110 in completing their order or request. In some instances, the machine-readable label 116 may be implemented using any form of one- or two-dimensional code that can be used to encode information and/or executable instructions (e.g., high-capacity color barcodes, NexCode, ShotCode, Qode, Data Matrix, CrontoSign, Aztec Code, barcodes, etc.).

In an embodiment, the agent bot 104, through the point-of-sale terminal 106, presents the machine-readable label 116 to the user 110. For example, if the point-of-sale terminal 106 implements a graphical interface (e.g., a touchscreen, a monitor, etc.), the agent bot 104 may transmit executable instructions to the point-of-sale terminal 106 to update the graphical interface to present the machine-readable label 116. In some examples, the agent bot 104 may transmit executable instructions to the point-of-sale terminal 106 to dynamically generate the machine-readable label 116 locally and to present the machine-readable label 116 to the user 110. For instance, the agent bot 104 may transmit, to the point-of-sale terminal 106, the information that is to be encoded in the machine-readable label 116. Accordingly, the point-of-sale terminal 106 may generate the machine-readable label 116 using the provided information such that the provided information is encoded in the machine-readable label 116.

The machine-readable label 116 may be presented to the user 110 with one or more instructions to the user 110 to utilize a computing device 114 (e.g., smartphone, etc.) to scan the machine-readable label 116. For example, the point-of-sale terminal 106 may present, along with the machine-readable label 116 one or more textual instructions that may instruct the user 110 to use their computing device 114 to scan the presented machine-readable label 116. Additionally, or alternatively, the agent bot 104 may use NLP, interactive voice recognition systems, or other forms of conversational voice algorithms and systems to communicate these instructions to the user 110 through the point-of-sale terminal 106. For example, the agent bot 104 may use these systems to transmit the communication “Please scan the QR code presented here to continue with your order.” This same communication may also be presented textually through the graphical interface implemented at the point-of-sale terminal 106.

When the user 110 uses their computing device 114 to scan the machine-readable label 116 from the point-of-sale terminal 106, the computing device 114 may automatically transmit a request to the brand platform service 102 to facilitate an alternative communications session between the user 110 and the agent bot 104. The request may include the identifying information associated with the user 110 and any other information associated with the order or request being submitted through the point-of-sale terminal 106. As noted above, this identifying information and other information may be encoded in the machine-readable label 116 such that, when the machine-readable label 116 is scanned using the computing device 114, the computing device 114 may extract the identifying information and the other information from the machine-readable label 116. Further, when the machine-readable label 116 is scanned using the computing device 114, the computing device 114 may automatically execute a browser application or other application through which the request to facilitate the alternative communications session between the user 110 and the agent bot 104 may be transmitted to the brand platform service 102. For example, if the machine-readable label 116 encodes a URI associated with a website or other resource associated with the brand platform service 102, the computing device 114 may automatically execute a browser application or other application implemented on the computing device 114, through which the URI may be used to access the website or other resource in order to transmit the request.

The alternative communications session may be facilitated by the brand platform service 102 in real-time and while the original communications session between the user 110 and the agent bot 104 facilitated through the point-of-sale terminal 106 is ongoing. For instance, while the user 110 and the agent bot 104 are engaged in a speech-based conversation through the point-of-sale terminal 106, the brand platform service 102 may facilitate the alternative communications session between the user 110 (through their computing device 114) and the agent bot 104 using any available communications channel. For example, the alternative communications session may be implemented through a text-based communications channel, such as through Short Message Service (SMS) messaging, Multimedia Messaging Service (MMS) messaging, online chat sessions (e.g., real-time transmission of text-based messages, etc.), and the like. As another illustrative example, the alternative communications session may be implemented through a different speech-based communications channel (e.g., telephony, Voice over Internet Protocol (IP), etc.), whereby the agent bot 104 may use NLP, interactive voice recognition systems, and other forms of conversational voice algorithms and systems to produce speech-based communications over the alternative communications session.

In an embodiment, as the agent bot 104 communicates with the user 110 over the alternative communications session, the agent bot 104 can transmit data corresponding to the alternative communications session to the point-of-sale terminal 106 for presentation to the user 110. For example, if the user 110, through the alternative communications session with the agent bot 104, communicates an order for one or more particular food items (e.g., “I'd like an order of fries and a cheeseburger”), the agent bot 104 may, in real-time, transmit data corresponding to this order to the point-of-sale terminal 106. This may cause the point-of-sale terminal 106 to present, such as through the graphical interface implemented on the point-of-sale terminal 106, the elements of the communicated order (e.g., “1× Fries,” “1× Cheeseburger”) along with any additional elements associated with the communicated order (e.g., price per food item, any additional fees and/or taxes, the total price for the order, etc.). Thus, while the user 110 is communicating with the agent bot 104 over the alternative communications session, the agent bot 104 may dynamically, and in real-time, present any supplemental information associated with the alternative communications session through the original communications session associated with the point-of-sale terminal 106.

In some instances, the agent bot 104 can automatically, and in real-time, process any communications exchanged over both the original and alternative communications sessions to determine whether to transfer these communications sessions to a live agent or other agent that may be able to address the underlying intent or other issue. For instance, if the agent bot 104 detects, from communications provided by the user 110, one or more particular anchor terms, the agent bot 104 may automatically transfer the communications sessions between the user 110 and the agent bot 104 to a live agent. As an illustrative example, if the user 110 indicates, through a communications session, that they have a food allergy (e.g., “I'm allergic to wheat,” “Does the cheeseburger have any soy products?,” “I have some food allergies. Can you tell me what's in these items?,” etc.), the agent bot 104 may automatically transfer the communications session to a live agent that may be more knowledgeable with regard to potential allergens in the items indicated by the user 110 and that may be better suited to ask clarifying questions to the user 110 over the communications session. As another illustrative example, if the user 110 indicates, through a communications session, that the agent bot 104 has not correctly identified their order (e.g., “No, I didn't say BBQ sauce; I said honey mustard,” “That should be two cheeseburgers, not one,” etc.), the agent bot 104 may determine that the user 110 is becoming frustrated or is otherwise disagreeing with the information provided by the agent bot 104. This detection of the user's frustration or disagreement may cause the agent bot 104 to automatically transfer the communications session to a live agent that may be able to reduce the user's frustration or otherwise address the user's disagreement with the user agent determinations.

In an embodiment, the agent bot 104 can automatically determine when the user 110 has completed providing their order or request. For instance, using the aforementioned machine learning algorithm or artificial intelligence, the agent bot 104 can automatically identify an opportunity to prompt the user 110 for payment associated with the order or request. As noted above, the machine learning algorithm or artificial intelligence utilized by the agent bot 104 may automatically, and in real-time, process any communications between the user 110 and the agent bot 104 through both the original and the alternative communications sessions as these communications are exchanged to identify an intent associated with these communications. As an illustrative example, if the user 110 states, over either the original or alternative communications session and after indicating one or more parameters associated with their order or request, “That's it!,” the agent bot 104 may determine that the user 110 has concluded providing their order or request. As another illustrative example, if the user 110 does not provide further communications over a threshold period of time (e.g., 15 seconds, 30 seconds, a minute, etc.) after communicating one or more parameters associated with an order or request, the agent bot 104 may prompt the user 110 to indicate whether they have completed providing their order or request. In response to this prompt, the agent bot 104 may monitor any subsequent communications over both the original and alternative communications sessions to determine whether the user 110 has provided an affirmative response (e.g., “Yes, that's it for my order,” “Yup!,” etc.).

If the agent bot 104 determines that the user 110 has completed submitting their order or request through either the original communications session facilitated through the point-of-sale terminal 106 or the alternative communications session facilitated through the user's computing device 114, the agent bot 104 may determine whether the computing device 114 is currently capable of supporting the transmission of payments, such as through rich messaging or through an application implemented on the computing device 114. For instance, the agent bot 104, through a payment orchestration system implemented by the brand platform service 102, may ping the user's computing device 114 to determine the present capabilities of the computing device 114 to transmit payments through rich messaging or through an application implemented on the computing device 114. If the agent bot 104 determines that the computing device 114 is capable of transmitting payments to the brand platform service 102 for the present order or request, the agent bot 104 may transmit a request to the computing device 114 to obtain a payment authorization that can be used to obtain a payment for the present order or request. The request to the computing device 114 may specify one or more characteristics of the order or request for which payment is being requested (e.g., items included in the order, a total cost associated with the order, an order identifier, a brand identifier, a communications session identifier, etc.). The request to the computing device 114 may be transmitted as a rich message generated according to the Rich Communication Services (RCS) protocol or any other available protocol that enables the transmission of rich messages. Alternatively, the request may be transmitted directly to an application implemented on the computing device 114 through which payments are supported.

The user 110, through the computing device 114, may submit a personal identification number (PIN), password, one or more forms of biometric information (e.g., fingerprints, retinal scans, facial scans, audial recording, video recording, etc.), or any other identifying information of the user 110 that may serve as an indication of authorization for the payment. Further, through the computing device 114, the user 110 may select a method of payment. For instance, through the computing device 114, the user 110 may provide their credit card information, banking information, digital wallet information, and the like. The provided authorization and payment information may be transmitted using a rich message via the RCS protocol or through any other available communications protocol as an encrypted data packet to the brand platform service 102. The encrypted data packet may include the payment authorization information provided by the user 110, as well as the payment information corresponding to the method of payment selected by the user 110. In response to obtaining the encrypted data packet from the computing device 114, the brand platform service 102 may evaluate the data packet determine whether the user 110 has provided their authorization for payment to be made to the brand for the submitted order or request. For instance, in response to obtaining the encrypted data packet from the computing device 114, the brand platform service 102 may use a cryptographic key or a shared secret to verify that the encrypted data packet is authentic and, if so, decrypt the encrypted data packet to obtain the user's payment information and authorization information for the payment. If the brand platform service 102 determines that the authorization information is valid, the brand platform service 102 may transmit the payment information provided by the user 110, as well as the unique identifier corresponding to the order or request, to a payment processing service, which may provide the payment to the brand.

In an embodiment, if the agent bot 104 determines that the user 110 is unable to provide payment for the order or request through their computing device 114, the agent bot 104 may transmit a notification to the point-of-sale terminal 106 to prompt the user 110 for payment. For instance, through the graphical interface implemented by the point-of-sale terminal 106, the agent bot 104 may prompt the user 110 for a payment for the corresponding order or request. If the point-of-sale terminal 106 implements a payment terminal (e.g., credit card reader, etc.), the user 110 may be prompted to provide payment through the payment terminal at the point-of-sale terminal 106. In some instances, the agent bot 104 may allow the user 110 to submit payment for the corresponding order or request through either the computing device 114 or the point-of-sale terminal 106, subject to the user's discretion. In such instances, the agent bot 104 need not determine that the user 110 is unable to provide payment through their computing device 114 prior to transmitting a notification to the point-of-sale terminal 106 to prompt the user 110 for payment.

In an embodiment, once payment has been received for the order or request submitted through the point-of-sale terminal 106 or through the alternative communications session between the user 110 and the brand, the agent bot 104 may communicate the order or request associated with the user 110 to one or more other point-of-sale systems 108 for fulfillment of the order or request. For instance, if the order or request corresponds to one or more food items requested by the user 110, the agent bot 104 may transmit the order or request to a kitchen order terminal associated with the brand. The kitchen order terminal may be used by one or more food preparers at the point-of-sale to view the order or request and to prepare the corresponding one or more food items for the user 110. In some instances, as updates are provided by the other point-of-sale systems 108 to the agent bot 104 with regard to fulfillment of the order or request, the agent bot 104 may communicate these updates to the user 110 through the point-of-sale terminal 106 and/or through the alternative communications session facilitated through the user's computing device 114.

In an embodiment, the brand platform service 102 records the communications sessions between the user 110 and the agent bot 104 in real-time and as communications are exchanged between the user 110 and the agent bot 104 in order to further dynamically train the machine learning algorithm or artificial intelligence. For example, as the user 110 and the agent bot 104 communicate with one another over the original and alternative communications sessions in real-time, the brand platform service 102 may determine whether the agent bot 104 is providing accurate responses to the user 110. As an illustrative example, if the user 110 indicates that they wish to order a cheeseburger but the agent bot 104 continuously indicates that the user 110 has indicated that they want a fish sandwich, the brand platform service 102 may determine that the agent bot 104 is incorrectly processing the user's communication regarding their order. Accordingly, the brand platform service 102 may annotate this exchange to indicate the agent bot's erroneous interpretation of the user's communication. This may serve as negative feedback that may be used to retrain the machine learning algorithm or artificial intelligence used by the agent bot 104 to process similar communications more accurately and correctly discern the conveyed information. Similarly, if a communications session is transferred from the agent bot 104 to a live agent as a result of the agent bot 104 being unable to process communications from the user 110, the brand platform service 102 may annotate these communications and any resolution provided by the live agent to train the machine learning algorithm or artificial intelligence to better identify similar communications and to provide a response similar to that provided by the live agent.

It should be noted that the machine learning algorithm or artificial intelligence may be continuously and constantly updated in real-time as different communications sessions between different users and agent bots occur and as corresponding orders or requests are processed. For instance, as the user 110 communicates with the agent bot 104 over the original and/or alternative communications session(s), the machine learning algorithm or artificial intelligence may, at the same time, be updated according to other ongoing communications sessions between other users and the agent bot 104 or other agent bots at different point-of-sale locations or through different point-of-sale terminals. Further, as feedback is received corresponding to these different communications sessions between different users and agent bots, the machine learning algorithm or artificial intelligence may be dynamically and continuously updated in real-time to improve the accuracy of the machine learning algorithm or artificial intelligence in providing accurate results.

In some embodiments, the machine-readable label 116 can be presented through the point-of-sale terminal 106 regardless of whether a user is present within a particular spatial range of the point-of-sale terminal 106. For example, the brand platform service 102 may provide a persistent machine-readable label 116 that is displayed at the location of the point-of-sale terminal 106. When the user 110 arrives at the point-of-sale terminal 106, the user 110 may choose whether to communicate with the agent bot 104 through the point-of-sale terminal 106 or to scan the machine-readable label 116 using their computing device 114 in order to transmit a request to the brand platform service 102 to initiate a communications session with the agent bot 104 that may be facilitated through the computing device 114.

If the user 110 scans the persistent machine-readable label 116 to facilitate the communications session between the user 110 and the agent bot 104 through the user's computing device 114, the brand platform service 102 may link the point-of-sale terminal 106 to this communications session. For example, as the agent bot 104 communicates with the user 110 over this communications session, the agent bot 104 can transmit data corresponding to this communications session to the point-of-sale terminal 106 for presentation to the user 110. Returning to a previously described example, if the user 110, through the communications session with the agent bot 104 facilitated through the computing device 114, communicates an order for one or more particular food items (e.g., “I'd like an order of fries and a cheeseburger”), the agent bot 104 may, in real-time, transmit data corresponding to this order to the point-of-sale terminal 106. This may cause the point-of-sale terminal 106 to present, such as through the graphical interface implemented on the point-of-sale terminal 106, the elements of the communicated order (e.g., “1× Fries,” “1× Cheeseburger”) along with any additional elements associated with the communicated order (e.g., price per food item, any additional fees and/or taxes, the total price for the order, etc.). Thus, while the user 110 is communicating with the agent bot 104 over a communications session facilitated through any device other than the point-of-sale terminal 106 (e.g., computing device 114, another computing device, etc.), the agent bot 104 may dynamically, and in real-time, present any information associated with this communications session through a communications session associated with the point-of-sale terminal 106.

In an embodiment, the machine-readable label 116 is dynamically modified in real-time as the user 110 is communicating with the agent bot 104 over a communications session based on interactions between the user 110 and the agent bot 104 over the communications session. For example, if the user 110 has initiated, over the communications session facilitated through the user's computing device 114 or other computing device not associated with the point-of-sale terminal 106, an order or other request, the agent bot 104 may generate a new machine-readable label that may be presented to the user 110 through the point-of-sale terminal 106. As noted above, the agent bot 104 may generate a machine-readable label using any identifying information associated with the user 110 and any other information associated with the order or request being submitted. If the agent bot 104 requires additional identifying information associated with the user 110, the agent bot 104, through the point-of-sale terminal 106, may dynamically, and automatically, obtain any identifying information associated with the user 110 (e.g., license plate number associated with the user's vehicle 112, the make and model of the user's vehicle 112, an image of the user 110 captured by the point-of-sale terminal 106, etc.). Using this identifying information and any information corresponding to the order or other request initiated by the user 110 over the communications session, the agent bot 104 may generate a dynamic machine-readable label that may be presented to the user 110 through the point-of-sale terminal 106.

The user 110 may elect to scan the dynamic machine-readable label presented through the point-of-sale terminal 106 while the user 110 is engaged in the communications session with the agent bot 104 through their computing device 114. For example, the user 110 may utilize a different computing device to scan the dynamic machine-readable label to request facilitation of a new communications session with the agent bot 104 over a preferred communications channel. As an illustrative example, if the user 110 is communicating with an agent bot 104 over a communications session facilitated through the user's computing device 114 but the user 110 wishes to communicate with the agent bot 104 through a different computing device that satisfies one or more of the user's accessibility needs, the user 110 may utilize this different computing device to scan the dynamic machine-readable label and resume the communications session with the agent bot 104. The identifying information associated with the user 110 and the information corresponding to the order or other request initiated by the user 110 encoded in the dynamic machine-readable label may be provided to the agent bot 104, which may utilize this information to resume the communications session with the user 110 over the alternative communications channel.

In an embodiment, a persistent machine-readable label implemented at the location associated with the point-of-sale terminal 106 can be used to link an existing order or other request previously submitted by the user 110 with an indication of the user's presence or arrival at the location. The persistent machine-readable label may encode information corresponding to the location, such that when the persistent machine-readable label is scanned, an indication of the user's presence at the location is provided. For example, a user 110, through an application or website associated with the point-of-sale (e.g., retailer, restaurant, etc.), may initiate a new order or other request that may be fulfilled at the point-of-sale location. Once the user 110 has initiated the new order or other request through the application or website, the user 110 may proceed to the point-of-sale location, where the user 110 may use their computing device 114 to scan the persistent machine-readable label. The persistent machine-readable label may cause the computing device 114 to execute the application or navigate the user 110, through a browser application, to the website used to initiate the new order or request. Further, computing device 114, through the application or website, may indicate the user's presence at the location associated with the point-of-sale terminal 106. This may allow for fulfillment of the order or other request at the point-of-sale location, facilitation of a communications session between the user 110 and an agent bot 104 to complete the order or other request at the point-of-sale location, and the like.

In some instances, at the point-of-sale location, the brand platform service 102 may implement various unique machine-readable labels that each correspond to different order locations at the point-of-sale location and that may be used to associate an order or request to an order location at the point-of-sale location. As an illustrative example, the brand platform service 102 may implement a unique machine-readable label at a parking space at the point-of-sale location. When a user 110 uses their computing device 114 from the parking space to submit an order or other request, such as through an application or website associated with the point-of-sale, the user 110 may be instructed to scan the machine-readable label at the parking space. The brand platform service 102, in response to obtaining location information encoded in the machine-readable label from the computing device 114 (such as through the application or website), the brand platform service 102 may associate the order or request with this location information. This may allow for fulfillment of the order or request at the particular location (e.g., parking space, etc.).

It should be noted that while point-of-sale terminals and point-of-sale locations are used throughout the present disclosure for the purpose of illustration, the real-time generation of dynamic and unique machine-readable labels that may be used to initiate a communications session between a user 110 and an agent bot 104 can be applied in additional and/or alternative environments. For example, the brand platform service 102 may implement a machine-readable label 116 on an automated teller machine (ATM) associated with a financial institution, where this machine-readable label 116 may initially encode location information corresponding to the location of the ATM and one or more communication options (e.g., phone number, a link to an application or website associated with the financial institution, etc.). If the user 110 utilizing the ATM requires assistance at the ATM location, the user 110 may use their computing device 114 to scan the presented machine-readable label 116, which may cause the computing device 114 to present the user 110 with one or more options for initiating a communications session with an agent bot 104. For example, if the machine-readable label 116 encodes a URI corresponding to a website through which the user 110 may chat with an agent bot 104, and a phone number associated with the brand platform service 102 and associated with an agent bot 104, the user 110 may be presented with corresponding options to either access the website to chat with the agent bot 104 or initiate a telephonic communications session with the agent bot 104. Further, when initiating the communications session with the agent bot 104, the computing device 114 may transmit the location information encoded in the machine-readable label 116 to the agent bot 104.

In an embodiment, if the user 110 inserts, into the ATM, their payment instrument (e.g., a credit card, a debit card, etc.), provides a PIN associated with the payment instrument, and/or otherwise provides any identifying information associated with the user 110, the ATM can automatically, and in real-time, dynamically update the machine-readable label 116 to encode this information. If the user 110 scans, using their computing device 114, this dynamically updated machine-readable label, this identifying information may be provided to the agent bot 104, which may use the identifying information to further assist the user 110 with regard to an order or other request that the user 110 is attempting to submit for fulfillment at the ATM. Further, the agent bot 104 may use this identifying information to authenticate the user 110. For example, if the machine-readable label 116 encodes a PIN associated with the payment instrument provided by the user 110, the agent bot 104, over the communications session facilitated through the user's computing device 114 or through the ATM itself, may prompt the user 110 to provide their PIN. If the PIN provided by the user 110 does not match the PIN encoded in the machine-readable label 116, the agent bot 104 may determine that the user 110 cannot be authenticated and may accordingly terminate the communications session. Alternatively, if the agent bot 104 determines that the PIN provided by the user 110 matches the PIN encoded in the machine-readable label 116, the agent bot 104 may continue the communications session with the user 110.

In some instances, the machine-readable label 116 may be presented through the ATM at specific times and/or in response to one or more triggering events. For example, if a transaction at the ATM is declined, the brand platform service 102, through the ATM, may present a machine-readable label 116 that encodes identifying information associated with the user 110 (e.g., any biometric information collected at the ATM (photos, fingerprints, etc.), a provided PIN, information corresponding to the payment instrument introduced to the ATM (card number, expiration date, etc.), etc.) and information corresponding to the transaction (e.g., timestamp, type of transaction, error code or other indicator of why the transaction was declined, etc.). The user 110 may use their computing device 114 to scan the presented machine-readable label 116 to request facilitation of a new communications session between the user 110 and an agent bot 104 through the computing device 114.

In some instances, the user 110 may be engaged in a communications session with an agent bot 104 (such as through an application provided by the financial institution, through a telephonic channel, etc.) prior to arriving at an ATM. The ATM may include a persistent machine-readable label 116 that encodes location information associated with the ATM and any other information that may be used to identify the particular ATM at the location (e.g., serial number, network address, etc.). When the user 110 arrives at the ATM, the user 110 may scan the persistent machine-readable label 116 to retrieve the encoded information associated with the ATM. The user 110, through their computing device 114, may transmit this information to the agent bot 104, which may use this information to confirm that the user 110 is present at the location associated with the ATM. Further, this may allow the agent bot 104 to link any transactions conducted through the ATM with the present communications session with the user 110.

In an embodiment, the real-time generation of dynamic and unique machine-readable labels that can be used to initiate a communications session between a user 110 and an agent bot 104 can be applied in the context of website environments. For instance, the user 110, through a desktop computer, may access a website associated with a particular brand, through which the user 110 may initiate a communications session with an agent bot 104 implemented by the brand platform service 102. For example, through this website, the user 110 may be engaged with the agent bot 104 over a chat session facilitated by the brand platform service 102.

During the course of this communications session, the user 110 may wish to continue this communications session on a different computing device, such as computing device 114. For instance, the user 110 may need to move away from their desktop computer or other stationary computing device in order to perform some other task. Accordingly, the user 110 may wish to transfer the communications session to a mobile computing device, such as computing device 114. The user 110, through the communications session, may communicate this request to the agent bot 104, which may generate a machine-readable label 116 that encodes identifying information associated with the user 110 (e.g., username, legal name, contact information, etc.) and information corresponding to the present communications session (e.g., identifier corresponding to the communications session, a timestamp, etc.). The agent bot 104 may display this newly generated machine-readable label 116 on the website, such as through an interface corresponding to the communications session between the user 110 and the agent bot 104.

The user 110, utilizing their mobile computing device 114, may scan the presented machine-readable label 116, which may cause the mobile computing device 114 to access the website (such as through a browser application) or an application associated with the particular brand installed on the mobile computing device 114 to resume the communications session. The mobile computing device 114 may provide the identifying information associated with the user 110 and the information corresponding to the present communications session extracted from the machine-readable label 116 to the agent bot 104. The agent bot 104 may process the information extracted from the machine-readable label 116 to resume the communications session with the user 110 through the user's mobile computing device 114.

As another illustrative example, if the user 110 is engaged with the agent bot 104 through a communications session facilitated through the user's mobile computing device 114, the user 110 may communicate a request to transfer the communications session to another computing device, such as a desktop computer or other stationary computing device. For instance, the user 110 may wish to continue the communications session on their desktop computer as it may be easier for the user 110 to review any communications through their desktop computer as opposed to their mobile computing device 114. Accordingly, the agent bot 104 may generate a machine-readable label 116 that encodes identifying information associated with the user 110 and information corresponding to the present communications session. The agent bot 104 may present this newly generated machine-readable label 116 through the user's mobile computing device 114 (such as through an interface associated with the communications session, etc.).

Once the machine-readable label 116 is presented through the user's mobile computing device 114, the user 110 may engage one or more integrated or peripheral devices (e.g., a camera, a scanner, etc.) associated with their desktop computer or other stationary computing device to scan the machine-readable label 116. The desktop computer or other stationary computing device may redirect the user 110 to the website associated with the particular brand to resume the communications session. The desktop computer or other stationary computing device may provide the identifying information associated with the user 110 and information corresponding to the present communications session to the agent bot 104 through the website. This may allow the agent bot 104 to resume the communications session with the user 110 through the desktop computer or other stationary computing device.

In some instances, the machine-readable label 116 may be generated by the agent bot 104 only after the user 110 has been authenticated by the brand. For example, if the user 110 wishes to transfer the communications session to another computing device, the agent bot 104 may determine whether the user 110 has been authenticated by the brand through the website used to initiate the communications session. If the user 110 has not been authenticated by the brand, the agent bot 104 may prompt the user 110 to provide credential information (such as through a login window) that may be used to authenticate the user 110. Once the user 110 has been authenticated, the agent bot 104 may generate the machine-readable label 116. The machine-readable label 116, in this particular example, may encode authentication information associated with the user 110. This authentication information may be used by the agent bot 104 to verify that the user 110 has been authenticated by the brand prior to continuing the communications session with the user 110 through another computing device.

It should be noted that while agent bots are used extensively throughout the present disclosure for the purpose of illustration, the methods and techniques described herein are applicable to communications sessions facilitated between users and other types of agents, such as human or live agents. For instance, the user 110 may initially engage with a human agent through the point-of-sale terminal 106 to communicate an order or other request that may be fulfilled at the point-of-sale location. If the human agent determines that the communications session between the user 110 and the human agent may be better facilitated through another communications channel, the human agent may transmit a request to the brand platform service 102 to generate a machine-readable label 116 that may be presented to the user 110 through the point-of-sale terminal 106. The machine-readable label 116 may be used in a similar manner to that described above. However, when the user 110 utilizes their computing device 114 to scan the machine-readable label 116, the alternative communications session may be facilitated between the user 110 and the human agent through the user's computing device 114.

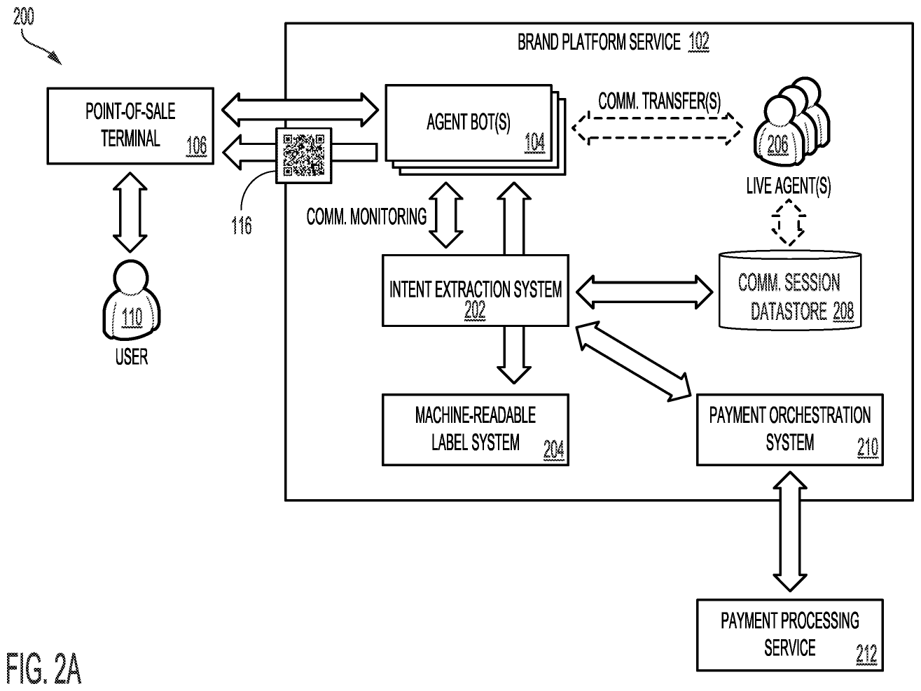

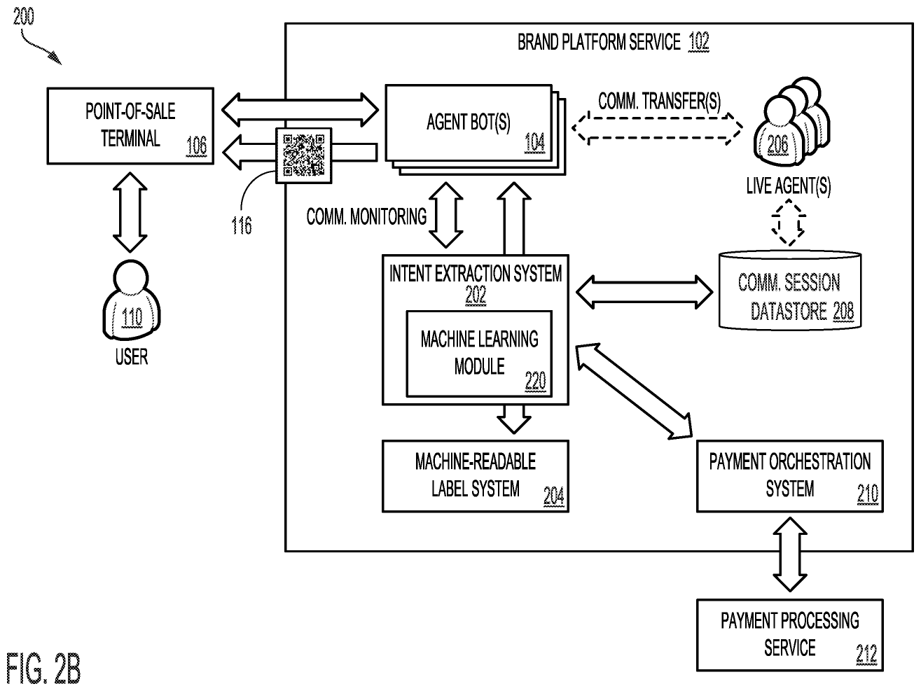

FIGS. 2A-2B show an illustrative example of an environment 200 in which an intent extraction system 202 associated with a brand platform service 102 monitors a communications session in real-time to determine whether to augment the communications session with a machine-readable label 116 usable to facilitate an alternative communications session in accordance with at least one embodiment. In the environment 200, a user 110 may approach a point-of-sale terminal 106 to initiate a communications session with an agent bot 104 through the point-of-sale terminal 106. As noted above, the point-of-sale terminal 106 may include one or more sensors that are implemented to detect when a user, such as user 110, has entered within a particular spatial range of the point-of-sale terminal 106. For example, if the user 110 is in a vehicle and the point-of-sale terminal 106 is implemented as a drive-thru menu board accessible through a drive-thru lane at the point-of-sale, the point-of-sale terminal 106, using the one or more sensors, may automatically detect when the vehicle, in the drive-thru lane, enters a pre-defined zone towards the point-of-sale terminal 106. In some instances, the point-of-sale terminal 106 may automatically detect the presence of the user 110 based on one or more interactions of the user 110 with the point-of-sale terminal 106. For example, the point-of-sale terminal 106 may detect when a user 110 speaks into a speaker system implemented by the point-of-sale terminal 106, engages one or more interfaces associated with the point-of-sale terminal 106 (e.g., a touchscreen, a touchpad, tactile buttons, etc.), and the like.

In an embodiment, if the point-of-sale terminal 106 detects the presence of a user 110, the point-of-sale terminal 106 transmits a notification to the brand platform service 102 to request initiation of a communications session between the user 110 and an agent bot 104. In response to the request, the brand platform service 102 may select an agent bot 104 that may engage the user 110 through the point-of-sale terminal 106. The brand platform service 102 may maintain various agent bots that may be implemented for different purposes. For instance, the agent bots can be configured for different capabilities. As an illustrative example, the brand platform service 102 may implement an agent bot that may be configured to communicate with users to obtain and process food-related orders. As another illustrative example, the brand platform service 102 may implement an agent bot that may be configured to communicate with users to assist these users in resolving any issues associated with automatic teller machines (ATMs) corresponding to a particular financial institution. In some instances, the brand platform service 102 may implement different agent bots for different types of communications channels. For example, the brand platform service 102 may implement a first set of agent bots configured to communicate with users over a speech-based communications channel and a second set of agent bots configured to communicate with users over a text-based communications channel.

In some instances, an agent bot 104 associated with the brand platform service 102 may continuously, and in real-time, monitor the point-of-sale terminal 106 to automatically detect when a user 110 is present before the point-of-sale terminal 106. Accordingly, if the agent bot 104 detects that a user 110 is present, the agent bot 104 may automatically facilitate the communications session between the agent bot 104 and the user 110 through the point-of-sale terminal 106. For example, if the agent bot 104 detects that the user 110 is present before the point-of-sale terminal 106, the agent bot 104 may initiate a communications session with the user 110 over the point-of-sale terminal 106 by transmitting one or more introductory communications (e.g., “Hi! How may I help you?,” “Welcome! May I take your order?,” etc.). These one or more introductory communications may be communicated through different types of communications channels (e.g., speech-based communications channels, text-based communications channels, etc.).

In an embodiment, as communications are exchanged in real-time between the user 110 and an agent bot 104 over the point-of-sale terminal 106, these communications may be automatically processed by an intent extraction system 202 implemented by the brand platform service 102 to determine, in real-time, an intent associated with the communications session. The intent extraction system 202 may be implemented as a computer system or application implemented by the brand platform service 102 to automatically, and in real-time, extract intents from communications exchanged between users and agent bots as these communications are exchanged. In some instances, the intent extraction system 202 may be implemented as a special-purpose computer system that includes one or more special-purpose processors that are physically configured to perform the operations described herein. In some instances, the intent extraction system 202 is configured to process these communications to identify one or more anchor terms or phrases that may be indicative of an intent. For example, if the user 110 indicates that they would like to place an order (“Hi! I'd like to place an order.”), the intent extraction system 202 may automatically process this communication to identify an anchor term or phrase associated with an intent corresponding to placing an order (e.g., “place an order”). Based on this intent, the intent extraction system 202 may provide this intent to the agent bot 104, which may determine an appropriate action corresponding to the intent (e.g., prompt the user 110 to provide their order (“Sure thing! What would you like?”), communicate one or more specials available to the user 110 (“Great! Here are today's special deals!”), etc.).

In an embodiment, and as illustrated in FIG. 2B, the intent extraction system 202 can implement a machine learning module 220 that includes a machine learning algorithm or artificial intelligence that is dynamically trained, in real-time, to process communications between users and agents in real-time and as these communications are exchanged in order to identify the intent expressed in these communications. The machine learning module 220 may be used to perform a semantic analysis of the communications (e.g., by identifying keywords, sentence structures, repeated words, punctuation characters and/or non-article words) to identify the intent expressed in these communications. An intent can also be determined, for example, based on user input (e.g., having selected one or more categories); and/or message-associated statistics (e.g., response latency, etc.).

The machine learning algorithm or artificial intelligence implemented by the machine learning module 220 may be dynamically trained in real-time using supervised learning techniques. For instance, a dataset of input communications and known intents included in the input communications can be selected for training of the machine learning algorithm or artificial intelligence implemented by the intent extraction system 202 through the machine learning module 220. The dataset of input communications may include historical communications, hypothetical communications, and/or a combination thereof. In some examples, the input communications can be obtained from administrators of the brand platform service 102, users associated with the brand platform service 102 (e.g., users that have previously engaged in communications sessions with agent bots or live agents associated with the brand platform service 102, etc.), or other sources associated with the brand platform service 102. In some implementations, known intents used to train the machine learning algorithm or artificial intelligence utilized by the intent extraction system 202 may include characteristics of these intents provided by the entities that generated the sample communications. The machine learning algorithm or artificial intelligence may be evaluated to determine, based on the input sample communications supplied to the machine learning algorithm or artificial intelligence, whether the machine learning algorithm or artificial intelligence is extracting the expected intents from these communications. Based on this evaluation, the machine learning algorithm or artificial intelligence may be modified (e.g., one or more parameters or variables may be updated) to increase the likelihood of the machine learning algorithm or artificial intelligence generating the desired results (e.g., expected intents).

In an embodiment, the intent extraction system 202 evaluates the communications between the user 110 and the agent bot 104 through the point-of-sale terminal 106 to determine whether additional information is required in order to extract or otherwise supplement the intent from these communications in order to allow for identification of an appropriate response. For instance, if the user 110 communicates, to the agent bot 104, that they would like more information regarding the ingredients of a particular food item offered by the brand, the intent extraction system 202 may determine that the user 110 may potentially have a food allergy and, accordingly, that the user 110 should be prompted as to whether they have such a food allergy. The intent extraction system 202 may transmit a request to the agent bot 104 to solicit this additional information from the user 110 over the communications session facilitated through the point-of-sale terminal 106. Responses provided by the user 110 may be automatically provided to the intent extraction system 202, which may use these responses and the previously obtained communications from the user 110 to extract the intent and supplement the intent with the additional information provided by the user 110. This may be used by the intent extraction system 202 to determine an appropriate action or response to the identified intent.

In an embodiment, the agent bot 104 uses NLP, interactive voice recognition systems, or other forms of conversational voice algorithms and systems to communicate with a user 110 through the point-of-sale terminal 106, such as through the speaker system implemented by the point-of-sale terminal 106 and through which a user 110 can verbally communicate with the agent bot 104 through the point-of-sale terminal 106. As the user 110 communicates with the agent bot 104 through the point-of-sale terminal 106, the agent bot 104, through the intent extraction system 202, may dynamically, and in real-time, process any communications from the user 110 to determine whether processing of the user's order or request is becoming difficult over the point-of-sale terminal 106. For example, if the intent extraction system 202 detects, based on communications from the user 110, that an elevated amount of environmental noise is obfuscating the user's communications, the intent extraction system 202 may determine than an alternative communications session should be established between the user 110 and the agent bot 104 (or other agent bot implemented for such alternative communications sessions) in order to determine the intent associated with the user 110. As another illustrative example, if the intent extraction system 202 determines that the user 110 has one or more accessibility needs (e.g., the user 110 is hearing impaired, the user 110 cannot understand the agent bot 104 over the point-of-sale terminal 106, etc.), the intent extraction system 202 may determine that an alternative communications session should be established between the agent bot 104 and the user 110 in order to identify the intent associated with the user 110 (e.g., fulfill the new order or request from the user 110, etc.).

If the intent extraction system 202 determines that an alternative communications session should be established between the user 110 and the agent bot 104 for a particular intent, the intent extraction system 202 may transmit a request to the agent bot 104 to facilitate this alternative communications session. In response to the request, the agent bot 104, through the point-of-sale terminal 106, may dynamically, and automatically, obtain any identifying information associated with the user 110 (e.g., license plate number associated with the user's vehicle, the make and model of the user's vehicle, an image of the user 110 captured by the point-of-sale terminal 106, etc.) and any other information associated with the order or request being submitted (e.g., an order number, a timestamp, a communications session identifier, etc.). The agent bot 104 may provide this collected information to a machine-readable label system 204 to request generation of a machine-readable label 116. The machine-readable label system 204 may be implemented as a computer system or application associated with the brand platform service 102.

In response to the request from the agent bot 104, the machine-readable label system 204 may generate a unique machine-readable label 116 that encodes the identifying information associated with the user 110 and any other information associated with the order or request being submitted. In some instances, the machine-readable label system 204 may encode, into the machine-readable label 116, a URI corresponding to a website that may be used to assist the user 110 in completing their order or request. For instance, the URI may correspond to a website that includes a menu associated with the brand that implements the point-of-sale terminal 106. The URI may additionally, or alternatively, correspond to a website or application through which the alternative communications session between the user 110 and the agent bot 104 may be facilitated. For instance, the URI may correspond to a website that may provide chat session capabilities. Through this website, the user 110 may engage the agent bot 104 through a chat session. In some instances, the machine-readable label 116 may encode executable instructions that may cause the user's computing device to execute an application associated with the brand.

As noted above, the agent bot 104 may present the machine-readable label 116 generated by the machine-readable label system 204 to the user 110 through the point-of-sale terminal 106. For example, if the point-of-sale terminal 106 implements a graphical interface (e.g., a touchscreen, a monitor, etc.), the agent bot 104 may transmit executable instructions to the point-of-sale terminal 106 to present the machine-readable label 116 through this graphical interface. It should be noted that, in some instances, the machine-readable label 116 may be generated by the point-of-sale terminal 106 instead of by the machine-readable label system 204. For example, the agent bot 104 may transmit executable instructions to the point-of-sale terminal 106 to dynamically generate the machine-readable label 116 locally and to present the machine-readable label 116 to the user 110. For instance, the agent bot 104 may transmit, to the point-of-sale terminal 106, the information that is to be encoded in the machine-readable label 116. Accordingly, the point-of-sale terminal 106 may generate the machine-readable label 116 using the provided information such that the provided information is encoded in the machine-readable label 116.

When presenting the machine-readable label 116 to the user 110 through the point-of-sale terminal 106, the agent bot 104 may provide the user 110 with a set of instructions for scanning or otherwise interacting with the machine-readable label 116. For instance, the agent bot 104, through the point-of-sale terminal 106, may provide textual instructions to the user 110 to utilize their computing device to scan the presented machine-readable label 116. Additionally, or alternatively, the agent bot 104 may use speech-based communications over the point-of-sale terminal 106 to communicate these instructions to the user 110.

If the user 110 utilizes their computing device (e.g., smartphone, etc.) to scan the machine-readable label 116, the instructions or other information encoded in the machine-readable label 116 may cause the computing device to automatically transmit a request to the brand platform service 102 to facilitate an alternative communications session between the user 110 and the agent bot 104. As noted above, the request may include the identifying information associated with the user 110 and any other information associated with the order or request being submitted through the point-of-sale terminal 106 and encoded in the machine-readable label 116. In response to this request, the brand platform service 102 may facilitate the alternative communications session through an alternative communications channel (e.g., a chat session presented through a website, SMS messaging, MMS messaging, electronic mail messaging, telephony or other speech-based communications session through the user's computing device, etc.).

The alternative communications session may be facilitated while the original communications session through the point-of-sale terminal 106 is ongoing. For example, as the agent bot 104 communicates with the user 110 over the alternative communications session, the agent bot 104 may simultaneously, and in real-time, transmit data corresponding to the alternative communications session to the point-of-sale terminal 106 for presentation to the user 110. Returning to an earlier described example, if the user 110, through the alternative communications session with the agent bot 104, communicates an order for one or more particular food items (e.g., “I'd like an order of fries and a cheeseburger”), the agent bot 104 may, in real-time, transmit data corresponding to this order to the point-of-sale terminal 106. This may cause the point-of-sale terminal 106 to present, such as through the graphical interface implemented on the point-of-sale terminal 106, the elements of the communicated order (e.g., “1× Fries,” “1× Cheeseburger”) along with any additional elements associated with the communicated order (e.g., price per food item, any additional fees, the total price for the order, etc.). Thus, while the user 110 is communicating with the agent bot 104 over the alternative communications session, the agent bot 104 may dynamically, and in real-time, present any supplemental information associated with the alternative communications session through the original communications session associated with the point-of-sale terminal 106.

As noted above, communications exchanged between the user 110 and the agent bot 104 may be automatically processed, in real-time and as these communications are exchanged, by the intent extraction system 202 to determine an intent associated with these communications. The intent extraction system 202 may process these communications regardless of whether they originated through the original communications session associated with the point-of-sale terminal 106 or through the alternative communications channel facilitated between the user 110 and the agent bot 104 through an alternative communications channel. Thus, as the user 110 and the agent bot 104 communicate over both communications sessions, the intent extraction system 202 may dynamically, and in real-time, process these communications to determine user intents.

In an embodiment, the intent extraction system 202 can dynamically, and in real-time, determine whether one or more communications sessions facilitated between the user 110 and the agent bot 104 should be transferred to a live agent 206. For instance, if the intent extraction system 202 identifies, from these communications, one or more particular anchor terms, the intent extraction system 202 may determine that the corresponding communications session(s) should be transferred from the agent bot 104 to a live agent 206. As an illustrative example, if the user 110 indicates, through a communications session, that they have a food allergy (e.g., “I'm allergic to wheat,” “I have some food allergies. Can you tell me what's in these items?,” etc.), the intent extraction system 202 may identify the anchor term “allergy” and, based on this anchor term, determine that the communications session is to be transferred to a live agent 206 that may be more knowledgeable with regard to potential allergens in the items indicated by the user 110 and that may be better suited to ask clarifying questions to the user 110 over the communications session. Accordingly, the intent extraction system 202 may automatically transfer the communications session from the agent bot 104 to a live agent 206. The live agent 206 may engage the user 110 through any of the communications channels associated with the particular communications session.

In an embodiment, communications exchanged between the user 110 and the agent bot 104 through any communications session is automatically recorded in a communications session datastore 208. The communications session datastore 208 may be a database (e.g., relational database, non-relational database, etc.) that is implemented to store, in real-time, communications associated with different communications sessions between users and agents (e.g., agent bots, live agents, etc.). As the user 110 communicates with either an agent bot 104 or a live agent 206, the brand platform service 102 may automatically store these communications in the communications session datastore 208. These communications may be associated with their corresponding communications sessions within the communications session datastore 208. For instance, each communications session established between a user and agent bot may be associated with a unique identifier that may be used to associate communications exchanged over the communications session with the communications session. In some instances, since multiple communications sessions may be established for a particular interaction between a user 110 and an agent bot 104, the brand platform service 102 may generate a unique identifier corresponding to the interaction and associate the multiple communications sessions and corresponding communications with this unique identifier.

When a communications session is transferred from an agent bot 104 to a live agent 206, the live agent 206 may retrieve, from the communications session datastore 208, any communications previously exchanged between the user 110 and the agent bot 104. This may allow the live agent 206 to determine what has been communicated to the user 110 with regard to a particular order or request and to identify any issues that may need to be resolved for the particular order or request. For example, if the user 110 has indicated that they are allergic to a particular ingredient, the live agent 206 may review these communications to identify the particular ingredient in question and to identify the context with regard to the user's concern regarding the particular ingredient. This may allow the live agent 206 to better tailor their response to the user 110.

As the intent extraction system 202 processes communications between the user 110 and the agent bot 104 in real-time as these communications are exchanged via the original and the alternative communications sessions, the intent extraction system 202 may automatically determine when the user 110 has completed providing their order or request. For example, using the machine learning module 220, the intent extraction system 202 may automatically process the communications to determine whether an opportunity exists to prompt the user 110 for payment associated with the order or request. For instance, if the user 110 states, over either the original or alternative communications session and after indicating one or more parameters associated with their order or request, “That's it!,” the intent extraction system 202 may determine that the user 110 has finished communicated their order or request to the agent bot 104. As another illustrative example, if the user 110 does not provide further communications over a pre-defined period of time after communicating one or more parameters associated with an order or request, the intent extraction system 202 may indicate, to the agent bot 104, that the agent bot 104 is to prompt the user 110 to indicate whether they have completed providing their order or request. The agent bot 104, through the intent extraction system 202, may automatically monitor, in real-time, any subsequent communications over both the original and alternative communications sessions to determine whether the user 110 has provided an affirmative response to the prompt.

If the user 110 provides an affirmative response to the prompt (e.g., the user 110 indicates that they have completed providing their order or request, etc.), the intent extraction system 202 may engage a payment orchestration system 210 of the brand platform service 102 to determine whether the user 110, through a computing device, is currently capable of supporting the transmission of payments to the brand platform service 102. The payment orchestration system 210 may be implemented using a computer system or application associated with the brand platform service 102. In an embodiment, to determine whether the user's computing device is capable of supporting the transmission of payments to the brand platform service 102, the payment orchestration system 210 can ping the user's computing device to determine the present capabilities of the computing device to transmit payments through rich messaging or through an application implemented on the computing device. If the user's computing device is capable of transmitting payments to the brand platform service 102 for the present order or request, the payment orchestration system 210, through the agent bot 104, may transmit a request to the computing device to obtain a payment authorization that can be used to obtain a payment for the present order or request. The user 110, through their computing device, may submit a PIN, password, one or more forms of biometric information, or any other identifying information of the user 110 that may serve as an indication of authorization for the payment. Further, through the computing device, the user 110 may select a method of payment.

The authorization and payment information provided by the user 110 may be transmitted using a rich message via the RCS protocol or through any other available communications protocol as an encrypted data packet to the payment orchestration system 210. In response to obtaining the encrypted data packet, the payment orchestration system 210 may evaluate the data packet determine whether the user 110 has provided their authorization for payment to be made to the brand for the submitted order or request. For instance, in response to obtaining the encrypted data packet, the payment orchestration system 210 may use a cryptographic key or a shared secret to verify that the encrypted data packet is authentic and, if so, decrypt the encrypted data packet to obtain the user's payment information and authorization information for the payment. If the payment orchestration system 210 determines that the authorization information is valid, the payment orchestration system 210 may transmit the payment information provided by the user 110, as well as the unique identifier corresponding to the order or request, to a payment processing service 212, which may process the payment associated with the order or request and to provide the payment to the brand for the order or request.

If the payment orchestration system 210 determines that the user 110 is unable to use their computing device to transmit a payment to the payment orchestration system 210 for the submitted order or request, the payment orchestration system 210 may prompt the agent bot 104 to instruct the user 110 to provide payment for the submitted order or request through a local payment mechanism (e.g., a credit card reader, payment to a live representative at the point-of-sale, etc.). In response, the agent bot 104 may transmit a notification to the point-of-sale terminal 106 to prompt the user 110 for payment. For instance, through the graphical interface implemented by the point-of-sale terminal 106, the agent bot 104 may prompt the user 110 for a payment for the corresponding order or request. If the point-of-sale terminal 106 implements a payment terminal, the user 110 may be prompted to provide payment through the payment terminal at the point-of-sale terminal 106. Once payment has been received, the order or request may be fulfilled, as described above.

As noted above, communications exchanged between the user 110 and the agent bot 104 may be automatically recorded within the communications session datastore 208. These communications may be recorded in the communications session datastore 208 in real-time as these communications are exchanged over one or more communications sessions. In an embodiment, the intent extraction system 202 can use these recorded communications to further dynamically train the machine learning algorithm or artificial intelligence implemented through the machine learning module 220. For example, as the user 110 and the agent bot 104 communicate with one another over the original and alternative communications sessions in real-time, the intent extraction system 202 may determine whether the machine learning module 220 is providing accurate responses to the user 110. As an illustrative example, if the user 110 indicates that they wish to order a cheeseburger but the agent bot 104 continuously indicates that the user 110 has indicated that they want a fish sandwich, the brand platform service 102 may determine that the agent bot 104 is incorrectly processing the user's communication regarding their order. Accordingly, the brand platform service 102 may annotate this exchange to indicate the agent bot's (and, ergo, the machine learning module's) erroneous interpretation of the user's communication. This may serve as negative feedback that may be used to retrain the machine learning algorithm or artificial intelligence to process similar communications more accurately and correctly discern the conveyed information. Similarly, if a communications session is transferred from the agent bot 104 to a live agent 206 as a result of the agent bot 104 being unable to process communications from the user 110, the brand platform service 102 may annotate these communications and any resolution provided by the live agent 206 through the communications session datastore 208 to train the machine learning algorithm or artificial intelligence to better identify similar communications and to provide a response similar to that provided by the live agent 206.

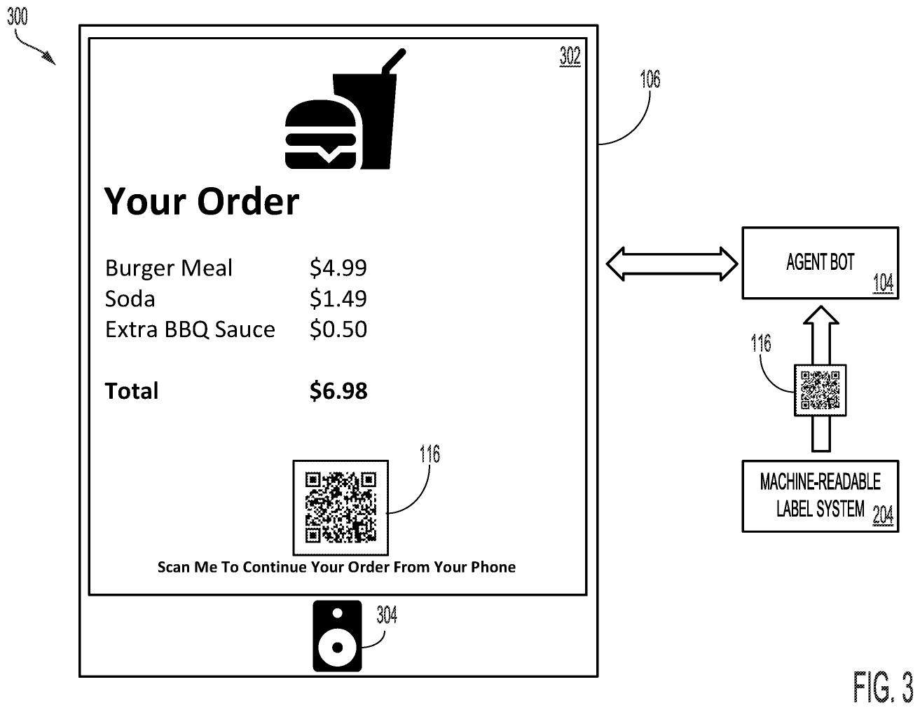

FIG. 3 shows an illustrative example of an environment 300 in which an interface 302 associated with a point-of-sale terminal 106 is updated to provide a machine-readable label 116 usable to facilitate an alternative communications session between a user and an agent bot 104 in accordance with at least one embodiment. In the environment 300, a user and an agent bot 104 may be engaged in a communications session facilitated through the point-of-sale terminal 106. As noted above, the point-of-sale terminal 106 may include a speaker system 304 through which a user can verbally communicate with the point-of-sale terminal 106 and that can reproduce any audial transmissions from the agent bot 104 associated with the point-of-sale terminal 106. Through this speaker system 304, the agent bot 104 may communicate with the user 110 using speech-based communications. In some instances, the speaker system 304 implemented on the point-of-sale terminal 106 may be configured with transmission and reception directionality in order to improve the capabilities of the point-of-sale terminal 106 in transmitting and receiving any audial signals. Further, the speaker system 304 may be configured with noise-canceling capabilities (e.g., active noise cancellation, adaptive noise cancellation, passive noise cancellation, etc.) in order to reduce or eliminate any ambient noise that may impact communications from the user to the agent bot 104.

In addition to implementing a speaker system 304, which may be used to facilitate a communications session between a user and the agent bot 104, the point-of-sale terminal 106 may further implement an interface 302 through which messages transmitted by the agent bot 104 to the user 110 may be displayed to the user 110 in real-time as these messages are received at the point-of-sale terminal 106. As illustrated in FIG. 3, for example, as the user communicates a food order through the speaker system 304, the agent bot 104 may automatically, and in real-time, transmit information corresponding to the food order that may be presented through the interface 302. For instance, if the user states, through the speaker system 304, “I would like a burger meal, a soda, and an extra portion of BBQ sauce,” the agent bot 104 (such as through the aforementioned intent extraction system 202 described above in connection with FIGS. 2A and 2B) may extract the elements of the order (e.g., “burger meal,” “soda,” “extra BBQ sauce”) and transmit an instruction to present these elements to the user through the interface 302, along with any additional elements associated with the communicated order (e.g., price per food item, any additional fees, the total price for the order, etc.). This may allow the user to determine whether the agent bot 104 has correctly processed the user's order or request through the point-of-sale terminal 106.

In an embodiment, if the agent bot 104 determines that an alternative communications session should be established between the user and the agent bot 104 to continue the order or other request being submitted by the user, the agent bot 104 may obtain a machine-readable label 116 that may be presented to the user through the interface 302. To generate the machine-readable label 116, the agent bot 104, through the point-of-sale terminal 106, may obtain identifying information associated with the user and any other information associated with the order or request being submitted through the point-of-sale terminal 106. The agent bot 104 may automatically provide this obtained information to the machine-readable label system 204 to request creation of the machine-readable label 116.

The machine-readable label 116 may encode the identifying information associated with the user and any other information associated with the order or request being submitted. In some instances, the machine-readable label system 204 may encode, into the machine-readable label 116, a URI corresponding to a website that may be used to assist the user in completing their order or request. For instance, the URI may correspond to a website that includes a menu associated with the brand that implements the point-of-sale terminal 106. The URI may additionally, or alternatively, correspond to a website or application through which the alternative communications session between the user and the agent bot 104 may be facilitated. Through this website, the user may engage the agent bot 104 through a chat session. In some instances, the machine-readable label 116 may encode executable instructions that may cause the user's computing device to execute an application associated with the brand.

As illustrated in FIG. 3, when the agent bot 104 obtains the machine-readable label 116 from the machine-readable label system 204, the agent bot 104 may update the interface 302 to present the machine-readable label 116. For example, the agent bot 104 may transmit executable instructions to the point-of-sale terminal 106 to update the interface 302 to present the machine-readable label 116. As noted above, in some instances, the machine-readable label 116 may be generated without the machine-readable label system 204. For example, the agent bot 104 may transmit executable instructions to the point-of-sale terminal 106 to dynamically generate the machine-readable label 116 locally and to present the machine-readable label 116 to the user 110. The agent bot 104 may transmit, to the point-of-sale terminal 106, the information that is to be encoded in the machine-readable label 116. Accordingly, the point-of-sale terminal 106 may generate the machine-readable label 116 using the provided information such that the provided information is encoded in the machine-readable label 116.

As noted above, the agent bot 104, through the interface 302, may provide one or more instructions for scanning the machine-readable label 116 to request facilitation of the alternative communications session and/or to obtain any additional information associated with the order or request being submitted. For example, the point-of-sale terminal 106 may present, along with the machine-readable label 116 and through the interface 302, one or more textual instructions that may instruct the user to use their computing device to scan the presented machine-readable label 116. For example, as illustrated in FIG. 3, the agent bot 104, through the interface 302, may present the textual communication “Scan Me To Continue Your Order From Your Phone.” The user may use this textual communication to determine how best to scan the machine-readable label 116 in order to initiate an alternative communications session with the agent bot 104 to continue providing the order or request.

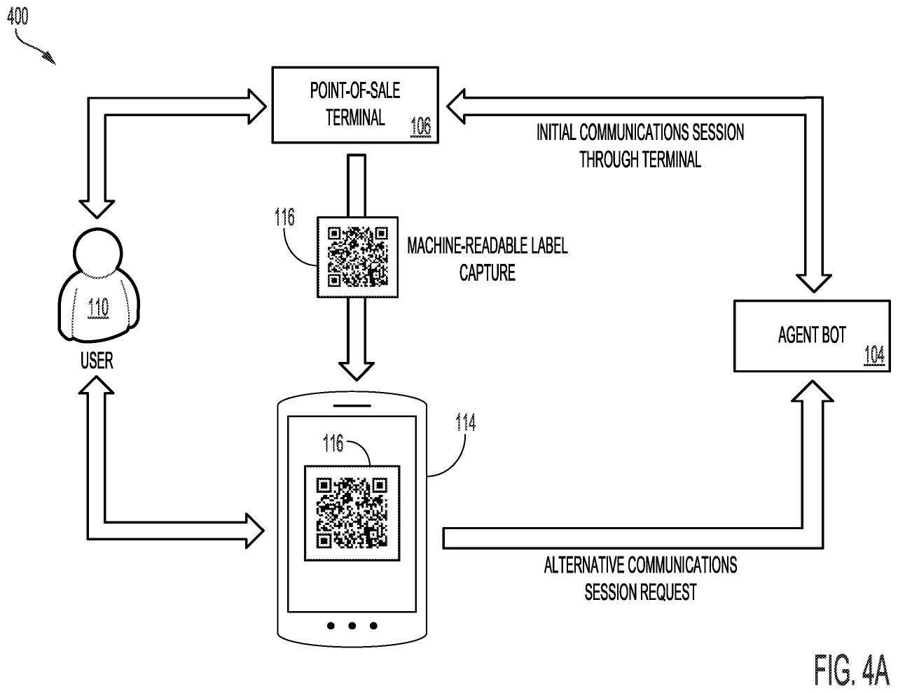

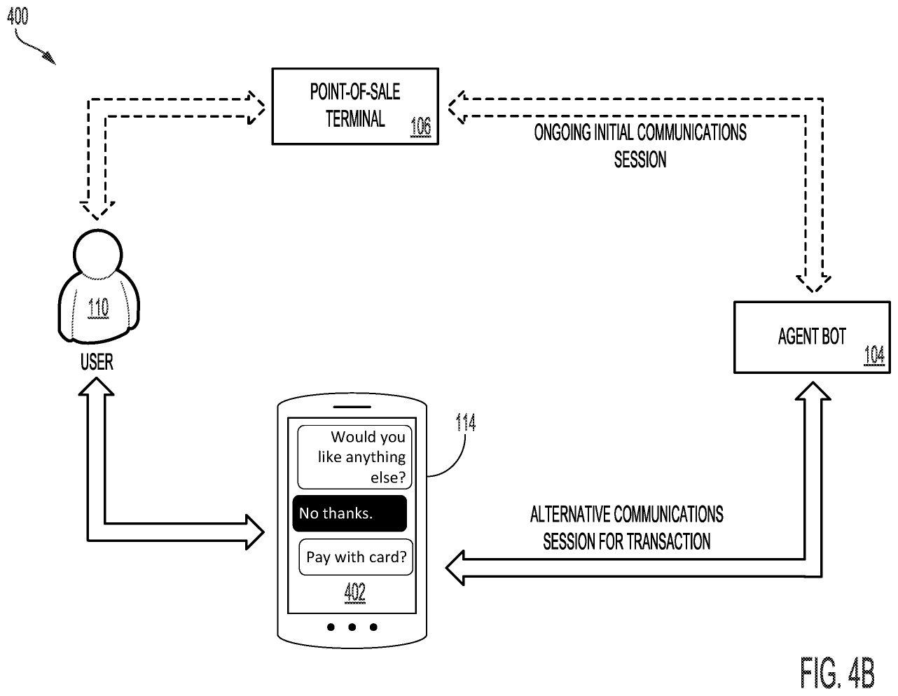

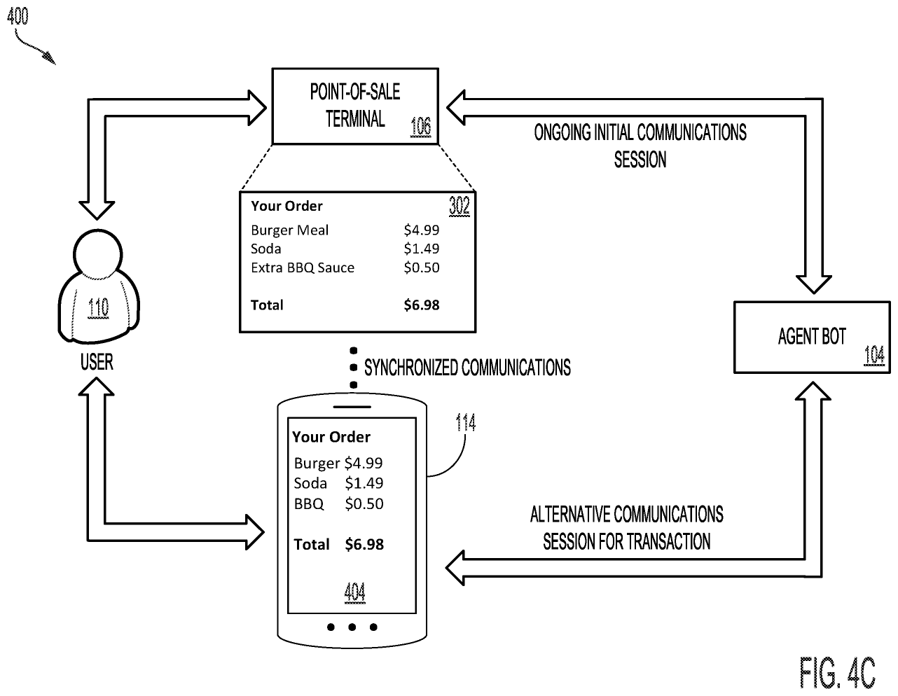

FIGS. 4A-4C show an illustrative example of an environment 400 in which a user 110, through a computing device, scans a provided machine-readable label 116 to request facilitation of an alternative communications session between the user 110 and an agent bot 104 in accordance with at least one embodiment. As illustrated in FIG. 4A, the agent bot 104, through the point-of-sale terminal 106, may present a machine-readable label 116 to the user 110. The machine-readable label 116 may be presented to the user 110 based on one or more factors. For instance, if the agent bot 104 determines, based on communications from the user 110 over the point-of-sale terminal 106, that it is unable to discern the user's intent (e.g., parameters corresponding to the user's order or request, actual words or phrases uttered by the user 110 over the point-of-sale terminal 106, etc.), the agent bot 104 may present the machine-readable label 116 to the user 110 through the point-of-sale terminal 106. As another illustrative example, if the agent bot 104 detects a significant amount of environmental or ambient noise that may obfuscate or otherwise hinder the communications session between the user 110 and the agent bot 104, the agent bot 104 may present the machine-readable label 116 to the user 110.

In some instances, the user 110, over the communications session facilitated through the point-of-sale terminal 106, may indicate that they would like to communicate with the agent bot 104 through an alternative communications session. For example, through the point-of-sale terminal 106, the user 110 may indicate that they are having a difficult time understanding the agent bot 104 through the point-of-sale terminal 106. As another illustrative example, through the point-of-sale terminal 106, the user 110 may indicate that they are unable to read what is being presented through the interface implemented on the point-of-sale terminal 106. In response to such an indication from the user 110, the agent bot 104 may present the machine-readable label 116 to the user 110 through the point-of-sale terminal 106.

When the user 110 uses their computing device 114 to scan the machine-readable label 116 from the point-of-sale terminal 106, the computing device 114 may automatically transmit a request to the agent bot 104 (through the brand platform service) to facilitate an alternative communications session between the user 110 and the agent bot 104. The request may include the identifying information associated with the user 110 and any other information associated with the order or request being submitted through the point-of-sale terminal 106. As noted above, this identifying information and other information may be encoded in the machine-readable label 116 such that, when the machine-readable label 116 is scanned using the computing device 114, the computing device 114 may extract the identifying information and the other information from the machine-readable label 116. Further, when the machine-readable label 116 is scanned using the computing device 114, the computing device 114 may automatically execute a browser application or other application through which the request to facilitate the alternative communications session between the user 110 and the agent bot 104 may be transmitted to the brand platform service 102.

The alternative communications session may be facilitated through the user's computing device 114. For example, through the user's computing device 114, the agent bot 104 may engage with the user 110 using text-based communications such as through SMS messaging, MMS messaging, online chat sessions (e.g., real-time transmission of text-based messages, etc.), and the like. As illustrated in FIG. 4B, the alternative communications session between the user 110 and the agent bot 104 is implemented through a real-time chat session presented through an interface 402 associated with the computing device 114. Through the alternative communications session, the agent bot 104 may continue the previous communications submitted through the initial communications session facilitated through the point-of-sale terminal 106. For example, if the user 110, through the initial communications session facilitated through the point-of-sale terminal 106, was in the process of submitting a food order, the agent bot 104 may prompt the user 110, through the alternative communications session, to continue submitting the food order. Further, through the alternative communications session, the agent bot 104 may provide contextual information associated with the initial communications session (e.g., any order or request parameters previously communicated by the user 110, etc.).

In an embodiment, the alternative communications session is facilitated in real-time as the initial communications session is ongoing. For example, as the agent bot 104 communicates with the user 110 over the alternative communications session, the agent bot 104 can transmit data corresponding to the alternative communications session in real-time to the point-of-sale terminal 106 for presentation to the user 110. Referring to an illustrative example described above, if the user 110, through the alternative communications session with the agent bot 104, communicates an order for one or more particular food items (e.g., “I'd like a burger meal, soda, and extra BBQ on the side”), the agent bot 104 may, in real-time, transmit data corresponding to this order to the point-of-sale terminal 106. As illustrated in FIG. 4C, this may cause the point-of-sale terminal 106 to present, through the interface 302 and in real-time as communications are exchanged over the alternative communications session, any elements associated with the communicated order (e.g., “1× Burger Meal for $4.99,” “1× Soda for $1.49,” “Extra BBQ Sauce for $0.50”). These communications through the initial communications session and the alternative communications session may be synchronized such that these communications are presented through both communications sessions simultaneously in real-time. For example, as illustrated in FIG. 4C, the information corresponding to the submitted order may be simultaneously presented through the interface 302 of the point-of-sale terminal 106 and through the interface 404 of the user's computing device 114.

As noted above, the agent bot 104 may automatically determine when the user 110 has completed providing their order or request based on communications exchanged between the user 110 and the agent bot 104 through both the original and the alternative communications sessions as these communications are exchanged. As an illustrative example, if the user 110 states, over either the original or alternative communications session and after indicating one or more parameters associated with their order or request, “That's it!,” the agent bot 104 may determine that the user 110 has concluded providing their order or request. As another illustrative example, if the user 110 does not provide further communications over a pre-defined period of time after communicating one or more parameters associated with an order or request, the agent bot 104 may prompt the user 110 to indicate whether they have completed providing their order or request. In response to this prompt, the agent bot 104 may monitor any subsequent communications over both the original and alternative communications sessions to determine whether the user 110 has provided an affirmative response. If the agent bot 104 determines that the user 110 has completed submitting their order or request through either the original communications session facilitated through the point-of-sale terminal 106 or the alternative communications session facilitated through the user's computing device 114, the agent bot 104 may prompt the user 110 for payment either through the original or the alternative communications sessions, as described above.

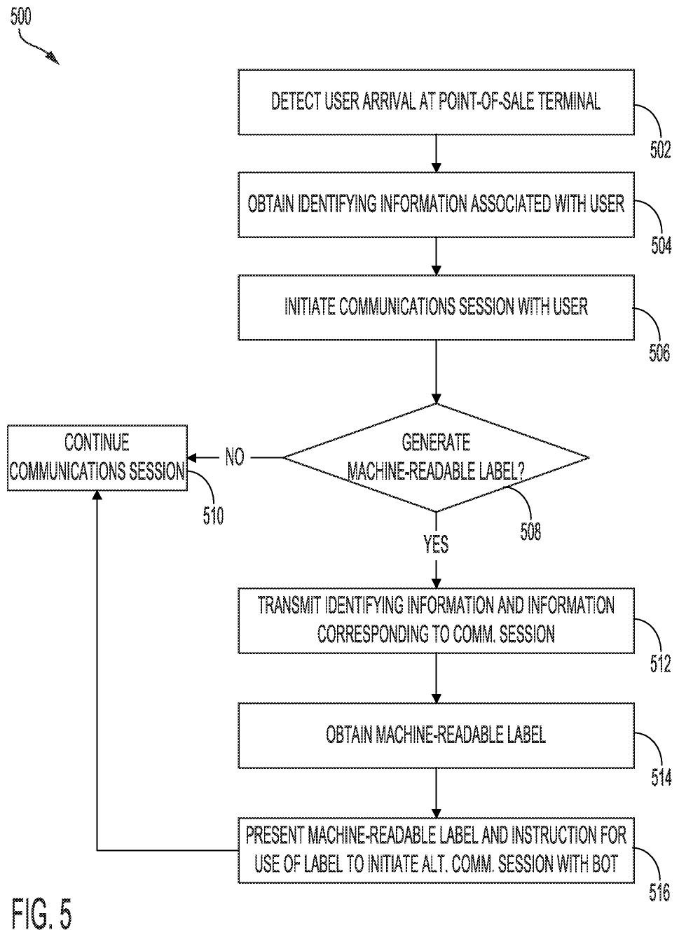

FIG. 5 shows an illustrative example of a process 500 for augmenting a communications session with a machine-readable label usable to facilitate an alternative communications session between a user and an agent bot in accordance with at least one embodiment. The process 500 may be performed by an agent bot implemented by the aforementioned brand platform service, in conjunction with the intent extraction system 202 and the machine-readable label system 204 described above in connection with FIGS. 2A and 2B. Further, the process 500 may be performed using one or more components of a point-of-sale terminal, through which an initial communications session between the agent bot and a user can be facilitated.

At step 502, the agent bot may detect the arrival of a user at the point-of-sale terminal. As noted above, the point-of-sale terminal may include one or more sensors that that are implemented to detect when a user has entered within a particular range of the point-of-sale terminal. For example, the one or more sensors may include a visual sensor that is implemented to capture one or more two-dimensional images in real-time and, from these one or more two-dimensional images, detect when a new object has entered within the field of vision of the visual sensor. As an illustrative example, the point-of-sale terminal, through this vision sensor, may continuously and in real-time capture two-dimensional images corresponding to a particular area surrounding the point-of-sale terminal (e.g., a portion of a drive-thru lane, a checkout line or area, etc.). The point-of-sale terminal may dynamically process these two-dimensional images in real-time to identify any changes to these two-dimensional images (e.g., monochrome and/or color changes, etc.) that may denote the presence of a user.

In some instances, the point-of-sale terminal may additionally, or alternatively, implement one or more motion sensors configured to detect when an object enters within the vicinity of the point-of-sale terminal. For example, when a user enters within the vicinity of the point-of-sale terminal, the one or more motion sensors (using ultrasonic sound waves, infrared energy waves, light, etc.) may detect the presence of the user. Additionally, or alternatively, the point-of-sale terminal may implement one or more audial sensors that may capture audial signals at the point-of-sale terminal to detect the arrival of a user. For example, if the one or more audial sensors detect user speech (e.g., “Hello? I'd like to place an order,” etc.), the point-of-sale terminal may determine that a user is present. As another illustrative example, the one or more audial sensors may be used to detect audial signals corresponding to a vehicle in operation (e.g., engine sounds, tire squeals, etc.) to determine that a user is present (such as through a drive-thru lane, etc.).

In an embodiment, the various signals captured using the one or more sensors implemented at the point-of-sale terminal can be processed in real-time by the agent bot to detect the arrival of a user at the point-of-sale terminal. For instance, the agent bot may use a machine learning algorithm or artificial intelligence that is dynamically trained to process any obtained signals from the point-of-sale terminal and based on this processing of the obtained signals, determine whether a user is present before the point-of-sale terminal. The machine learning algorithm or artificial intelligence may be trained using supervised, unsupervised, reinforcement, or other such training techniques. For example, a set of data may be analyzed using one of a variety of machine learning algorithms or artificial intelligence to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, meta-learning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning algorithm or artificial intelligence to facilitate identification of correlations between captured signals and the presence or absence of a user. The machine learning algorithm or artificial intelligence may be evaluated to determine, based on the sample inputs supplied to the machine learning algorithm or artificial intelligence, whether the machine learning algorithm or artificial intelligence is producing accurate correlations between captured signals and the determination regarding user presence. Based on this evaluation, the machine learning algorithm or artificial intelligence may be modified to increase the likelihood of the machine learning algorithm or artificial intelligence identifying the desired correlations. The machine learning model may further be dynamically trained by soliciting feedback from users as to the efficacy of correlations provided by the machine learning algorithm or artificial intelligence (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

If the agent bot detects that a user has arrived at the point-of-sale terminal, the agent bot, at step 504, may obtain identifying information associated with the user. For example, using the aforementioned sensors implemented at the point-of-sale terminal, if the user is in a vehicle that has approached the point-of-sale terminal, the agent bot may determine the license plate number associated with the user's vehicle, the make and model of the user's vehicle, an image of the user within the vehicle, and the like. As another example, if the user has approached the point-of-sale terminal (such as through a checkout line, etc.), the agent bot, through the point-of-sale terminal, may collect biometric information related to the user. In some instances, to obtain identifying information associated with the user, the agent bot, through the point-of-sale terminal, may prompt the user to provide particular identifying information. For example, the agent bot may prompt the user to provide their name, contact information (e.g., electronic mail address, phone number, username associated with the brand, etc.), or other information that may be used to uniquely identify the user.

At step 506, the agent bot, through the point-of-sale terminal, may initiate a communications session with the user. For instance, the agent bot may transmit a speech-based communication to the user over the point-of-sale terminal to welcome the user to the point-of-sale location (e.g., “Hi! Welcome to Sample Brand. May I take your order?”). As another illustrative example, the agent bot may update an interface associated with the point-of-sale terminal to provide information that may be useful to the user in communicating with the agent bot (e.g., a menu, one or more instructions, one or more messages, etc.). Using this information, the user may determine how best to communicate with the agent bot with regard to their order or request.

As noted above, the agent bot may use a machine learning algorithm or artificial intelligence to automatically, and autonomously, process communications from the user through the point-of-sale terminal in real-time as these communications are exchanged through the point-of-sale terminal. The machine learning algorithm may be used to perform a semantic analysis of the responses in order to identify any information in these communications that may correspond to an order or request. Further, using this machine learning algorithm or artificial intelligence, the agent bot may extract an intent associated with the communications session between the user and the agent bot through the point-of-sale terminal. Further, the machine learning algorithm or artificial intelligence may be dynamically trained to process, in real-time, any communications from the user (and any other ambient signals collected at the point-of-sale terminal) to determine whether processing of the user's order or request is becoming difficult over the point-of-sale terminal. For example, through the processing of communications and other ambient signals exchanged over the point-of-sale terminal, the agent bot may determine whether there is an elevated amount of environmental noise that is obfuscating the user's communications. As another illustrative example, through the processing of communications and other ambient signals exchanged over the point-of-sale terminal, the agent bot may determine whether the user has one or more accessibility needs (e.g., the user is hearing impaired, the user cannot understand the agent bot over the point-of-sale terminal, etc.).

As noted above, based on these communications exchanged between the user and the agent bot, the agent bot may determine whether an alternative communications session should be facilitated between the user and the agent bot in order to complete the order or request being submitted by the user. For example, if the agent bot determines that there is an elevated amount of environmental noise at the point-of-sale terminal location and/or the user has one or more accessibility needs, the agent bot may determine that an alternative communications session should be established between the agent bot and the user. As another illustrative example, through the aforementioned machine learning algorithm or artificial intelligence, the agent bot may detect one or more anchor terms or phrases that may indicate a need to establish an alternative communications session between the user and the agent bot for the order or request. For example, if the user states, through the point-of-sale terminal, “I can't understand what you're asking,” the agent bot may process this statement in real-time using the machine learning algorithm or artificial intelligence to detect the anchor phrase “can't understand.” This anchor phrase may be used by the agent bot to determine that the user is having a difficult time understanding the agent bot, thereby requiring an alternative communications session to continue the order or other request being submitted by the user.

Based on this aforementioned determination, the agent bot, at step 508, may determine whether to generate a machine-readable label that may be used to facilitate the alternative communications session. For example, if the agent bot determines that the communications session facilitated over the point-of-sale terminal is acceptable (e.g., the user has not expressed any issues related to the communications session, the agent bot does not have any issues processing user communications, etc.), the agent bot, at step 510, may continue this communications session without facilitating an additional (e.g., alternative) communications session.

If the agent bot determines that an alternative communications session should be facilitated between the user and the agent bot (e.g., a machine-readable label is to be generated), the agent bot, at step 512, may transmit the collected identifying information associated with the user and any information corresponding to the communications session (e.g., any collected order or request information, a communications session identifier, an order or request identifier, etc.) to a machine-readable label system for creation of a unique machine-readable label that may be used to facilitate the alternative communications session between the user and the agent bot.

In response to the request from the agent bot, the machine-readable label system may generate the unique machine-readable label. The unique machine-readable label may encode the identifying information associated with the user and the other information associated with the order or request being submitted. The machine-readable label may further encode a URI corresponding to a website that may be used to assist the user in completing their order or request. For instance, the URI may correspond to a website that includes a menu associated with the brand that implements the point-of-sale terminal. The URI may additionally, or alternatively, correspond to a website or application through which the alternative communications session between the user and the agent bot may be facilitated. The machine-readable label system may transmit the unique machine-readable label to the agent bot, which, at step 514, may obtain the machine-readable label.

At step 516, the agent bot may present the machine-readable label to the user, along with any instructions for use of the machine-readable label to initiate the alternative communications session. For example, if the point-of-sale terminal implements a graphical interface, the agent bot may transmit executable instructions to the point-of-sale terminal to update the graphical interface to present the machine-readable label. Further, the agent bot may transmit executable instructions to the point-of-sale terminal to present, along with the machine-readable label, one or more textual instructions that may instruct the user to scan the presented machine-readable label. Additionally, or alternatively, the agent bot may use NLP, interactive voice recognition systems, or other forms of conversational voice algorithms and systems to communicate these instructions to the user through the point-of-sale terminal. For example, the agent bot may use these systems to transmit the communication “Please scan the QR code presented here to continue with your order.” This same communication may also be presented textually through the graphical interface implemented at the point-of-sale terminal.

It should be noted that the agent bot may continue the communications session over the point-of-sale terminal (step 510) even after the machine-readable label is presented for facilitating the alternative communications session. As noted above, the alternative communications session may be facilitated while the original communications session between the user and agent bot through the point-of-sale terminal is ongoing. Thus, both communications sessions may be used simultaneously and elements of these communications sessions may be synchronized such that these elements are presented, in real-time and in a synchronized manner, over both communications sessions, as described above.

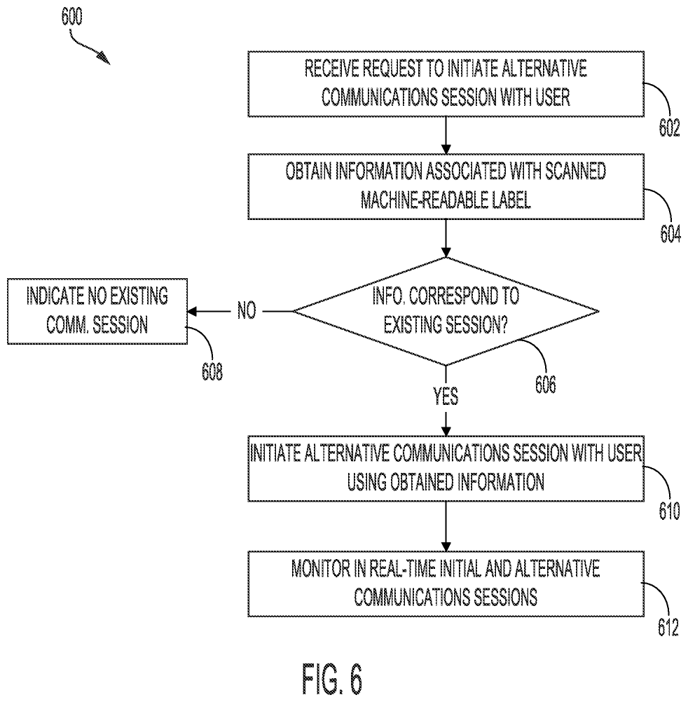

FIG. 6 shows an illustrative example of a process 600 for facilitating an alternative communications session between a user and an agent bot in response to the scanning of a machine-readable label associated with an initial communications session in accordance with at least one embodiment. The process 600 may be performed by a brand platform service that implements one or more agent bots to facilitate communications sessions between users and these one or more agent bots on behalf of one or more brands (e.g., fast-food restaurants, financial institutions, retail outlets, etc.).

At step 602, the brand platform service may receive a request to initiate an alternative communications session between a user and an agent bot implemented by the brand platform service. As noted above, the user may be presented with a machine-readable label through an original communications session between the user and an agent bot implemented by the brand platform service. When the user scans this machine-readable label using their computing device (e.g., smartphone, etc.), the computing device may automatically transmit a request to the brand platform service to facilitate an alternative communications session between the user and an agent bot that the user may be communicating with over the original communications session through a point-of-sale terminal.

The request generated in response to the user scanning the machine-readable label may include identifying information associated with the user and any other information associated with the order or request being submitted through the point-of-sale terminal. As noted above, this identifying information and other information may be encoded in the machine-readable label such that, when the machine-readable label is scanned, this identifying information and the other information may be extracted from the machine-readable label. The extracted information may be included in the request to the brand platform service. Thus, at step 604, the brand platform service may obtain this information associated with the scanned machine-readable label.

At step 606, the brand platform service may process this obtained information to determine whether the information corresponds to an existing communications session between the user and the agent bot. As noted above, communications exchanged between the user and the agent bot through any communications session are automatically recorded in a communications session datastore. As the user communicates with either an agent bot or a live agent, the brand platform service may automatically store these communications in the communications session datastore. These communications may be associated with their corresponding communications sessions within the communications session datastore. As noted above, the machine-readable label may encode a unique identifier corresponding to the original communications session facilitated through a point-of-sale terminal and between the user and an agent bot. Using this unique identifier, the brand platform service may query the communications session datastore to evaluate the communications exchanged between the user and the agent bot over this original communications session. Based on this evaluation, the brand platform service may determine whether the original communications session is ongoing (e.g., the user is still engaged in the communications session with the agent bot, the user has not departed from the point-of-sale terminal location, the user has not indicated that they are departing from the point-of-sale terminal location, the communications session has not been automatically or manually terminated, etc.).

If the brand platform service determines that the machine-readable label does not correspond to an existing or ongoing communications session, the brand platform service, at step 608, may indicate that there is no existing communications session associated with the machine-readable label. For example, the brand platform service may transmit a notification to the user over the user's computing device to indicate that the original communications session has been terminated and that the order or request the user has attempted to submit cannot be fulfilled (e.g., the user has left the point-of-sale location so any requested food items cannot be provided to the user, etc.). In some instances, the brand platform service may invite the user to initiate a new communications session with an agent bot if the particular order or request may be fulfilled remotely (e.g., an order for one or more products can be shipped to the user's home address, etc.). This may allow the user to continue their communications with an agent bot through the alternative communications channel.

If the brand platform service determines that the information encoded in the machine-readable label corresponds to an existing communications session (e.g., a communications session facilitated through a point-of-sale terminal, etc.), the brand platform service, at step 610, may initiate the alternative communications session between the user and the agent bot using the obtained information. As noted above, this alternative communications session may be facilitated by the brand platform service while the original communications session between the user and the agent bot facilitated through the point-of-sale terminal is ongoing. For example, while the user and the agent bot are engaged in a speech-based conversation through the point-of-sale terminal, the brand platform service may facilitate the alternative communications session between the user (through the user's computing device) and the agent bot using any available communications channel (e.g., speech-based, text-based, etc.).

At step 612, the brand platform service may monitor, in real-time, both the initial and alternative communications sessions between the user and the agent bot. For example, the brand platform service may automatically, and in real-time, process any communications exchanged over both the original and alternative communications sessions to determine whether the user has completed providing their order or request. As an illustrative example, if the user states, over either the original or alternative communications session and after indicating one or more parameters associated with their order or request, that the user has completed submitting their order (e.g., “That's all for me,” etc.), the brand platform service may determine that the user has concluded providing their order or request. As another illustrative example, if the user does not provide further communications over a pre-defined period of time after communicating one or more parameters associated with an order or request, the brand platform service may cause the agent bot to prompt the user to indicate whether they have completed providing their order or request. In response to this prompt, the brand platform service, through the agent bot, may monitor any subsequent communications over both the original and alternative communications sessions to determine whether the user has provided an affirmative response. Additionally, through the monitoring of the initial and alternative communications sessions, the brand platform service may determine whether any other actions may be performed, such as prompting the user for payment for the order or request, transferring one or more of the communications sessions to a live agent, and the like.

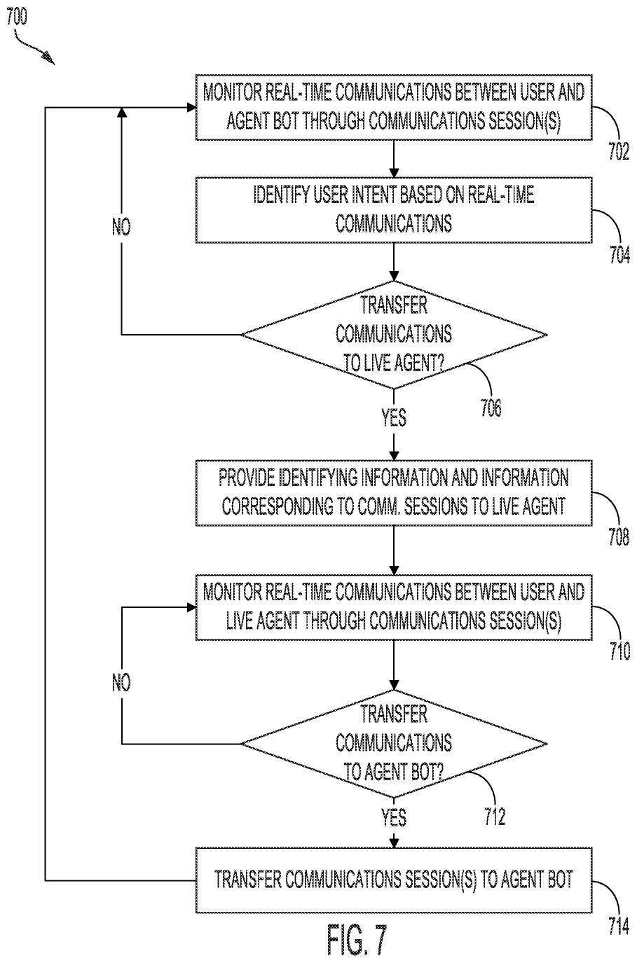

FIG. 7 shows an illustrative example of a process 700 for monitoring in real-time communications between a user and an agent bot through one or more communications sessions to determine whether to transfer a communications session from the agent bot to a live agent in accordance with at least one embodiment. The process 700 may be performed by an intent extraction system implemented by the brand platform service 102. As noted above, the intent extraction system may be implemented as a computer system or application implemented by the brand platform service to automatically, and in real-time, extract intents from communications exchanged between users and agent bots as these communications are exchanged and to identify one or more operations that may be performed based on the extracted intents.

At step 702, the intent extraction system may monitor communications exchanged between a user and an agent bot over one or more communications sessions in real-time as these communications are exchanged. For instance, the intent extraction system may continuously, and in real-time, process any communications exchanged between the user and the agent bot over any communications sessions facilitated between the user and the agent bot as these communications are exchanged. Through this real-time and dynamic processing of the communications exchanged between the user and the agent bot, the intent extraction system may, at step 704, identify a user intent. For instance, the intent extraction engine may process these communications in real-time to identify one or more anchor terms or phrases that may be indicative of an intent. Returning to an earlier described illustrative example, if the user indicates that they would like to place an order (“Hi! I'd like to place an order”), the intent extraction system may automatically process this communication to identify an anchor term associated with an intent corresponding to placing an order (e.g., “place an order”). Based on this intent, the intent extraction system may provide this intent to the agent bot, which may determine an appropriate action corresponding to the intent (e.g., prompt the user to provide their order, communicate one or more specials available to the user, etc.).

At step 706, the intent extraction system may determine whether to transfer one or more of the active communications sessions (e.g., the original communications session facilitated through the point-of-sale terminal, the alternative communications session facilitated through the user's computing device, etc.) from the agent bot to a live agent. For example, if the intent extraction system identifies, from these communications, one or more particular anchor terms or phrases, the intent extraction system may determine that the corresponding communications session(s) should be transferred from the agent bot to a live agent. Returning to an earlier described illustrative example, if the user indicates, through a communications session, that they have a food allergy, the intent extraction system may identify the anchor term “allergy” and, based on this anchor term, determine that the communications session is to be transferred to a live agent that may be more knowledgeable with regard to potential allergens in the items indicated by the user and that may be better suited to ask clarifying questions to the user over the communications session. As another illustrative example, if the intent extraction system identifies an intent corresponding to user confusion or other inability to appropriately communicate with the agent bot (e.g., the agent bot is unable to answer the user's question, the agent bot is incorrectly processing the user's communications, etc.), the intent extraction system may determine that the communications session is to be transferred to a live agent that may be better suited to communicate with the user.

If the intent extraction system determines that the one or more communications sessions are to continue with the agent bot, the intent extraction system may continue to monitor these communications sessions in real-time as communications are exchanged between the user and the agent bot. However, if the intent extraction system determines that the one or more communications sessions are to be transferred to a live agent, the intent extraction system, at step 708, may provide identifying information corresponding to the user and information corresponding to the communications sessions to a live agent. As noted above, communications exchanged between the user and the agent bot through any communications session is automatically recorded in the communications session datastore. For instance, as the user communicates with an agent bot, the communications exchanged between the user and the agent bot may be automatically stored in the communications session datastore. These communications may be associated with their corresponding communications sessions within the communications session datastore. Each communications session established between a user and agent bot may be associated with a unique identifier that may be used to associate communications exchanged over the communications session with the communications session. In some instances, since multiple communications sessions may be established for a particular interaction between a user and an agent bot, a unique identifier may be generated that corresponds to the multiple communications sessions and corresponding communications. This unique identifier may be provided to the live agent, which may use the unique identifier to obtain the identifying information associated with the user and the information corresponding to these communications sessions (e.g., exchanged communications, actions performed, etc.).

At step 710, the intent extraction system may monitor the real-time communications between the user and the live agent through the one or more communications sessions facilitated by the brand platform service. Similar to the operations described above for monitoring the real-time communications between the user and the agent bot, the intent extraction system may continuously, and in real-time, process any communications exchanged between the user and the live agent over these communications as these communications are exchanged. Through this real-time and dynamic processing of the communications exchanged between the user and the live agent, the intent extraction system may identify any user intents.

At step 712, the intent extraction system may determine whether to transfer the one or more communications sessions between the user and the live agent to the agent bot. For instance, if the intent extraction system determines, based on the identified user intent, that the live agent has addressed the user's issue (e.g., identifying allergens associated with an order or request, resolving any user confusion resulting from communication with the agent bot, confirming user selections from a menu, etc.), the intent extraction system may determine that the one or more communications sessions may be transferred back to the agent bot for completion of the order or request being submitted by the user. In some instances, the intent extraction system may determine that the one or more communications sessions may be transferred back to the agent bot if particular intents are detected. For example, as noted above, agent bots can be configured for different capabilities and to handle different intents. Accordingly, if the intent extraction system detects any of these intents in real-time from communications between the user and the live agent as these communications are exchanged, the intent extraction system may determine that the one or more communications sessions may be transferred to an agent bot from the live agent.

If the intent extraction system determines that the one or more communications sessions are to remain with the live agent, the intent extraction system may continue monitoring the real-time communications between the user and live agent as these communications are exchanged. Alternatively, if the intent extraction system determines that the one or more communications sessions may be transferred back to the agent bot, the intent extraction system, at step 714, may transfer these one or more communications sessions back to the agent bot. For instance, the intent extraction system may transmit executable instructions to the agent bot to access the communications session datastore to retrieve any available information corresponding to the communications exchanged between the user and the live agent in order to determine how to resume these communications over the one or more communications sessions. Accordingly, the agent bot may resume its communications with the user over the one or more communications sessions.

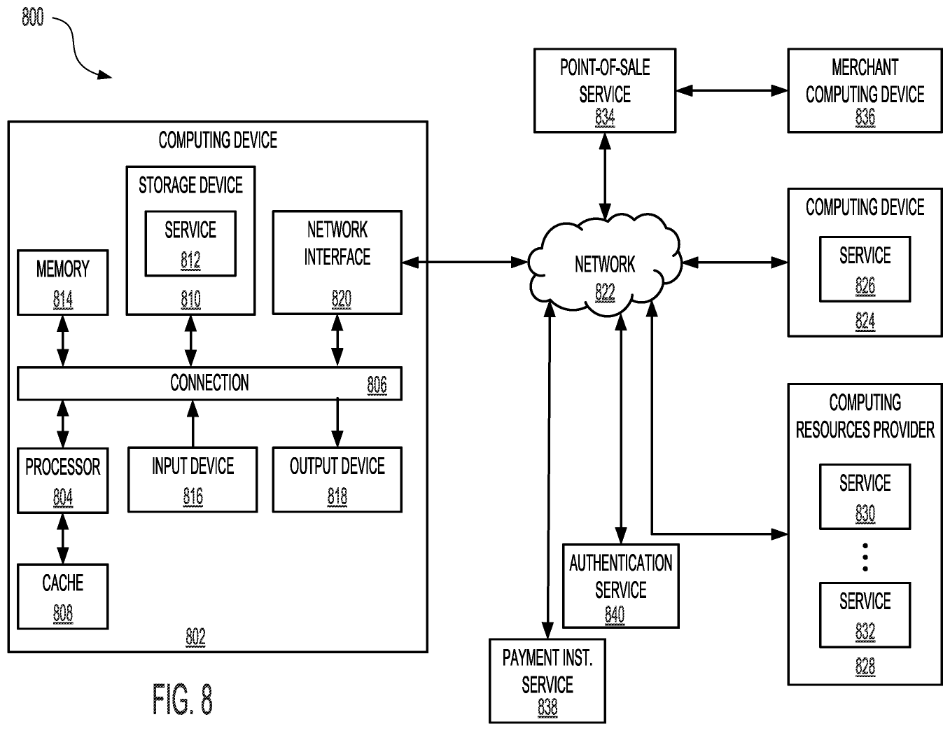

FIG. 8 illustrates a computing system architecture 800 including various components in electrical communication with each other using a connection 806, such as a bus, in accordance with some implementations. Example system architecture 800 includes a processing unit (CPU or processor) 804 and a system connection 806 that couples various system components including the system memory 820, such as ROM 818 and RAM 816, to the processor 804. The system architecture 800 can include a cache 802 of high-speed memory connected directly with, in close proximity to, or integrated as part of the processor 804. The system architecture 800 can copy data from the memory 820 and/or the storage device 808 to the cache 802 for quick access by the processor 804. In this way, the cache can provide a performance boost that avoids processor 804 delays while waiting for data. These and other modules can control or be configured to control the processor 804 to perform various actions.

Other system memory 820 may be available for use as well. The memory 820 can include multiple different types of memory with different performance characteristics. The processor 804 can include any general purpose processor and a hardware or software service, such as service 1 810, service 2 812, and service 3 814 stored in storage device 808, configured to control the processor 804 as well as a special-purpose processor where software instructions are incorporated into the actual processor design. The processor 804 may be a completely self-contained computing system, containing multiple cores or processors, a bus, memory controller, cache, etc. A multi-core processor may be symmetric or asymmetric.

To enable user interaction with the computing system architecture 800, an input device 822 can represent any number of input mechanisms, such as a microphone for speech, a touch-sensitive screen for gesture or graphical input, keyboard, mouse, motion input, speech and so forth. An output device 824 can also be one or more of a number of output mechanisms known to those of skill in the art. In some instances, multimodal systems can enable a user to provide multiple types of input to communicate with the computing system architecture 800. The communications interface 826 can generally govern and manage the user input and system output. There is no restriction on operating on any particular hardware arrangement and therefore the basic features here may easily be substituted for improved hardware or firmware arrangements as they are developed.

Storage device 808 is a non-volatile memory and can be a hard disk or other types of computer readable media which can store data that are accessible by a computer, such as magnetic cassettes, flash memory cards, solid state memory devices, digital versatile disks, cartridges, RAMs 816, ROM 818, and hybrids thereof.

The storage device 808 can include services 810, 812, 814 for controlling the processor 804. Other hardware or software modules are contemplated. The storage device 808 can be connected to the system connection 806. In one aspect, a hardware module that performs a particular function can include the software component stored in a computer-readable medium in connection with the necessary hardware components, such as the processor 804, connection 806, output device 824, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDNO modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
detecting a user at a point-of-sale terminal, wherein the point-of-sale terminal is associated with an agent, and wherein the agent communicates with users through a communications channel associated with the point-of-sale terminal;
identifying one or more characteristics associated with the user, wherein the one or more characteristics are used to associate a communications session between the user and the agent with the user;
initiating the communications session between the user and the agent, wherein the communications session is facilitated through the point-of-sale terminal;
dynamically generating in real-time a machine-readable label associated with the communications session, wherein the machine-readable label encodes the one or more characteristics associated with the user and information corresponding to the communications session;
providing the machine-readable label, wherein when the machine-readable label is received at the point-of-sale terminal, the point-of-sale terminal presents the machine-readable label;
receiving a request to initiate an alternative communications session between the user and the agent, wherein the request includes the one or more characteristics associated with the user and the information corresponding to the communications session extracted from the machine-readable label; and
facilitating the alternative communications session.

2. The computer-implemented method of claim 1, wherein the alternative communications session is facilitated while the communications session is ongoing through the point-of-sale terminal.

3. The computer-implemented method of claim 1, further comprising:
identifying in real-time an intent corresponding to ongoing communications exchanged between the user and the agent through the communications session and the alternative communications session; and
automatically transferring the alternative communications session to another agent, wherein the alternative communications session is transferred to the other agent according to the intent.

4. The computer-implemented method of claim 1, wherein the machine-readable label is a Quick Response (QR) code.

5. The computer-implemented method of claim 1, wherein the user is detected as a result of one or more sensors implemented on the point-of-sale terminal detecting the user.

6. The computer-implemented method of claim 1, further comprising:
encoding a location associated with the point-of-sale terminal in the machine-readable label, wherein the location is used to customize communications provided through the alternative communications session.

7. The computer-implemented method of claim 1, further comprising:
receiving a payment request over the communications session;
transmitting an authorization request for a payment over the alternative communications session; and
receiving authorization data over the alternative communications session, wherein the authorization data is used to obtain the payment.

8. The computer-implemented method of claim 1, wherein the machine-readable label is dynamically generated as communications are exchanged over the communications session.

9. The computer-implemented method of claim 1, wherein the request to initiate the alternative communications session is received as a result of the machine-readable label being scanned using a computing device associated with the user.

10. The computer-implemented method of claim 1, wherein the alternative communications session is facilitated using an alternative communications channel between the user and the agent.

11. A system, comprising:
one or more processors; and
memory storing thereon instructions that, as a result of being executed by the one or more processors, cause the system to:
detect a user at a point-of-sale terminal, wherein the point-of-sale terminal is associated with an agent, and wherein the agent communicates with users through a communications channel associated with the point-of-sale terminal;
identify one or more characteristics associated with the user, wherein the one or more characteristics are used to associate a communications session between the user and the agent with the user;
initiate the communications session between the user and the agent, wherein the communications session is facilitated through the point-of-sale terminal;
dynamically generate in real-time a machine-readable label associated with the communications session, wherein the machine-readable label encodes the one or more characteristics associated with the user and information corresponding to the communications session;
provide the machine-readable label, wherein when the machine-readable label is received at the point-of-sale terminal, the point-of-sale terminal presents the machine-readable label;
receive a request to initiate an alternative communications session between the user and the agent, wherein the request includes the one or more characteristics associated with the user and the information corresponding to the communications session extracted from the machine-readable label; and
facilitate the alternative communications session.

12. The system of claim 11, wherein the alternative communications session is facilitated while the communications session is ongoing through the point-of-sale terminal.

13. The system of claim 11, wherein the instructions further cause the system to:
identify in real-time an intent corresponding to ongoing communications exchanged between the user and the agent through the communications session and the alternative communications session; and
automatically transfer the alternative communications session to another agent, wherein the alternative communications session is transferred to the other agent according to the intent.

14. The system of claim 11, wherein the machine-readable label is a Quick Response (QR) code.

15. The system of claim 11, wherein the user is detected as a result of one or more sensors implemented on the point-of-sale terminal detecting the user.

16. The system of claim 11, wherein the instructions further cause the system to:
encode a location associated with the point-of-sale terminal in the machine-readable label, wherein the location is used to customize communications provided through the alternative communications session.

17. The system of claim 11, wherein the instructions further cause the system to:
receive a payment request over the communications session;
transmit an authorization request for a payment over the alternative communications session; and
receive authorization data over the alternative communications session, wherein the authorization data is used to obtain the payment.

18. The system of claim 11, wherein the machine-readable label is dynamically generated as communications are exchanged over the communications session.

19. The system of claim 11, wherein the request to initiate the alternative communications session is received as a result of the machine-readable label being scanned using a computing device associated with the user.

20. The system of claim 11, wherein the alternative communications session is facilitated using an alternative communications channel between the user and the agent.

21. A non-transitory, computer-readable storage medium storing thereon executable instructions that, as a result of being executed by one or more processors of a computer system, cause the computer system to:
detect a user at a point-of-sale terminal, wherein the point-of-sale terminal is associated with an agent, and wherein the agent communicates with users through a communications channel associated with the point-of-sale terminal;
identify one or more characteristics associated with the user, wherein the one or more characteristics are used to associate a communications session between the user and the agent with the user;
initiate the communications session between the user and the agent, wherein the communications session is facilitated through the point-of-sale terminal;
dynamically generate in real-time a machine-readable label associated with the communications session, wherein the machine-readable label encodes the one or more characteristics associated with the user and information corresponding to the communications session;
provide the machine-readable label, wherein when the machine-readable label is received at the point-of-sale terminal, the point-of-sale terminal presents the machine-readable label;
receive a request to initiate an alternative communications session between the user and the agent, wherein the request includes the one or more characteristics associated with the user and the information corresponding to the communications session extracted from the machine-readable label; and
facilitate the alternative communications session.

22. The non-transitory, computer-readable storage medium of claim 21, wherein the alternative communications session is facilitated while the communications session is ongoing through the point-of-sale terminal.

23. The non-transitory, computer-readable storage medium of claim 21, wherein the executable instructions further cause the computer system to:
identify in real-time an intent corresponding to ongoing communications exchanged between the user and the agent through the communications session and the alternative communications session; and
automatically transfer the alternative communications session to another agent, wherein the alternative communications session is transferred to the other agent according to the intent.

24. The non-transitory, computer-readable storage medium of claim 21, wherein the machine-readable label is a Quick Response (QR) code.

25. The non-transitory, computer-readable storage medium of claim 21, wherein the user is detected as a result of one or more sensors implemented on the point-of-sale terminal detecting the user.

26. The non-transitory, computer-readable storage medium of claim 21, wherein the executable instructions further cause the computer system to:
encode a location associated with the point-of-sale terminal in the machine-readable label, wherein the location is used to customize communications provided through the alternative communications session.

27. The non-transitory, computer-readable storage medium of claim 21, wherein the executable instructions further cause the computer system to:
receive a payment request over the communications session;
transmit an authorization request for a payment over the alternative communications session; and
receive authorization data over the alternative communications session, wherein the authorization data is used to obtain the payment.

28. The non-transitory, computer-readable storage medium of claim 21, wherein the machine-readable label is dynamically generated as communications are exchanged over the communications session.

29. The non-transitory, computer-readable storage medium of claim 21, wherein the request to initiate the alternative communications session is received as a result of the machine-readable label being scanned using a computing device associated with the user.

30. The non-transitory, computer-readable storage medium of claim 21, the alternative communications session is facilitated using an alternative communications channel between the user and the agent.
